(19) United States
(12) Patent Application Publication
(10) Pub. No.: US 2025/0229178 A1
(43) Pub. Date: Jul. 17, 2025

(54) FUNCTION CONTROL DISPLAY METHOD AND APPARATUS, TERMINAL, AND STORAGE MEDIUM

(71) Applicant: Tencent Technology (Shenzhen) Company Limited, Shenzhen (CN)

(72) Inventors: Yajing XU, Shenzhen (CN); Ruijuan PAN, Shenzhen (CN); Zi MENG, Shenzhen (CN); Xueyong CHEN, Shenzhen (CN); Chengsheng PENG, Shenzhen (CN); Tong ZHOU, Shenzhen (CN); Weiping FAN, Shenzhen (CN); Beijin LI, Shenzhen (CN); Yinxiang SUN, Shenzhen (CN); Jiaming CHEN, Shenzhen (CN); Yi ZENG, Shenzhen (CN); Muyu XU, Shenzhen (CN); Zhiwei WANG, Shenzhen (CN); Qinglong MA, Shenzhen (CN); Yuren CHEN, Shenzhen (CN)

(21) Appl. No.: 19/096,572

(22) Filed: Mar. 31, 2025

Related U.S. Application Data
(63) Continuation of application No. PCT/CN2024/076315, filed on Feb. 6, 2024.

(30) Foreign Application Priority Data
Mar. 17, 2023 (CN) 202310305058.6

(51) Int. Cl. A63F 13/533; A63F 13/2145; A63F 13/5255; A63F 13/5375; G06F 3/04815; G06F 3/04886

(52) U.S. Cl. CPC A63F 13/533; A63F 13/2145; A63F 13/5255; G06F 3/04815; G06F 3/04886; A63F 13/5375

(57) ABSTRACT

This application discloses a function control display method performed by a computer device. The method includes: displaying a scene interface of a virtual scene including a virtual object and a touch entry of a virtual compass being displayed on the scene interface; blurring, in response to a touch operation on the touch entry without interrupting a process corresponding to the virtual scene, the virtual scene displayed on the scene interface, displaying, on the scene interface on which the blurring has been performed, a scene in which the virtual compass appears in the virtual scene when being activated by the virtual object, and displaying, around the virtual compass, a plurality of function controls associated with the virtual compass. In the solution provided in embodiments of this application, simplicity of the scene interface is ensured, and a need of switching the scene interface to display the function controls is eliminated.

### CROSS-REFERENCE TO RELATED APPLICATIONS

This application is a continuation application of PCT Patent Application No. PCT/CN2024/076315, entitled “FUNCTION CONTROL DISPLAY METHOD AND APPARATUS, TERMINAL, AND STORAGE MEDIUM” filed on Feb. 6, 2024, which claims priority to Chinese Patent Application 202310305058.6, entitled “FUNCTION CONTROL DISPLAY METHOD AND APPARATUS, TERMINAL, AND STORAGE MEDIUM” and filed on Mar. 17, 2023, both of which are incorporated herein by reference in their entirety.

### FIELD OF THE TECHNOLOGY

Embodiments of this application relate to the field of computer technologies, and in particular, to a function control display method and apparatus, a terminal, and a storage medium.

### BACKGROUND OF THE DISCLOSURE

With the rapid development of computer technologies, game applications have increasingly diversified functions. During running of a game, generally, a plurality of function controls are displayed on a scene interface of a virtual scene in response to a click/tap operation of a user, so that the user triggers corresponding functions by using the function controls. However, because a game application has many function controls, when a plurality of function controls are displayed on a game interface, the scene interface appear cluster, resulting in a poor display effect of the scene interface. In addition, switching between a game scene and the function controls needs to be performed frequently. As a result, a lot of human-machine interaction resources are consumed, and a game process is interrupted. This affects visual experience, and increases use of interruption resources.

### SUMMARY

Embodiments of this application provide a function control display method and apparatus, a terminal, and a storage medium, to save system resources and improve a display effect of a scene interface. Technical solutions are as follows.

According to an aspect, a function control display method is performed by a computer device. The method includes:
displaying a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions;
blurring, in response to a touch operation on the touch entry, the virtual scene displayed on the scene interface; and displaying, on the scene interface, the virtual compass appearing in the virtual scene after being activated by the virtual object, and displaying the plurality of function controls around the virtual compass.

According to another aspect, a computer device includes a processor and a memory. The memory has at least one computer program stored therein, and the at least one computer program is loaded and executed by the processor to cause the computer device to implement operations performed in the function control display method according to the foregoing aspect.

According to another aspect, a non-transitory computer-readable storage medium has at least one computer program stored thereon, and the at least one computer program is loaded and executed by a processor of a computer device to cause the computer device to implement operations performed in the function control display method according to the foregoing aspect.

In the solutions provided in embodiments of this application, a virtual compass is used as a medium, a plurality of function controls are integrated in a touch entry of a virtual compass. Through the touch entry of the virtual compass, the virtual compass and the function controls appearing in the virtual scene when being activated by the virtual object is displayed, by blurring the virtual scene, on a scene interface on which the blurring has been performed, so that when the virtual compass and the function controls appear when being called, a user can still view the blurred virtual scene. This ensures that a process of a game is not interrupted when the calling of the virtual compass and the function controls is displayed, and also avoids visual impact brought by the virtual scene, to further ensure clarity of the virtual compass and the function controls that are displayed. In addition, the plurality of called function controls are displayed around the virtual compass, to simulate an effect that the virtual compass controls the plurality of function controls. In this way, simplicity of the scene interface is ensured, and a need of switching the scene interface to display the function controls is eliminated. This avoids visual impact caused by the switching of the interface, reduces a feeling of interruption caused by the switching of the interface, and ensures continuity of the game. In this way, continuity of the displayed virtual scene can be ensured, so that the user can be immersed in the displayed virtual scene, to improve user experience.

### BRIEF DESCRIPTION OF THE DRAWINGS

To describe technical solutions of embodiments of this application more clearly, the following briefly describes the accompanying drawings required for describing embodiments. Apparently, the accompanying drawings in the following descriptions show only some embodiments of this application, and a person of ordinary skill in the art may still derive other drawings from these accompanying drawings without creative efforts.

FIG. 1 is a schematic diagram of a structure of an implementation environment according to an embodiment of this application.

FIG. 2 is a flowchart of a function control display method according to an embodiment of this application.

FIG. 3 is a flowchart of another function control display method according to an embodiment of this application.

FIG. 4 is a schematic diagram of a virtual compass according to an embodiment of this application.

FIG. 5 is a flowchart of another function control display method according to an embodiment of this application.

FIG. 6 is a flowchart of another function control display method according to an embodiment of this application.

FIG. 7 is a flowchart of another function control display method according to an embodiment of this application.

FIG. 8 is a schematic diagram of a scene interface according to an embodiment of this application.

FIG. 9 is a flowchart of another function control display method according to an embodiment of this application.

FIG. 10 is a flowchart of another function control display method according to an embodiment of this application.

FIG. 11 is a flowchart of another function control display method according to an embodiment of this application.

FIG. 12 is a schematic diagram of another scene interface according to an embodiment of this application.

FIG. 13 is a schematic diagram of another scene interface according to an embodiment of this application.

FIG. 14 is a flowchart of another function control display method according to an embodiment of this application.

FIG. 15 is a schematic diagram of another scene interface according to an embodiment of this application.

FIG. 16 is a schematic diagram of another scene interface according to an embodiment of this application.

FIG. 17 is a schematic diagram of another scene interface according to an embodiment of this application.

FIG. 18 is a schematic diagram of another scene interface according to an embodiment of this application.

FIG. 19 is a schematic diagram of a structure of a function control display apparatus according to an embodiment of this application.

FIG. 20 is a schematic diagram of a structure of a terminal according to an embodiment of this application.

### DESCRIPTION OF EMBODIMENTS

To make objectives, technical solutions, and advantages of embodiments of this application clearer, implementations of this application are described below in further detail with reference to the accompanying drawings.

Terms “first”, “second”, “third”, “fourth”, “fifth”, “sixth”, and the like used in this application may be used for describing various concepts in this specification. However, unless otherwise specified, the concepts are not limited by the terms. The terms are merely used for distinguishing one concept from another concept. For example, without departing from the scope of this application, a first state may be referred to as a second state, and similarly, the second state may be referred to as the first state.

In terms “at least one”, “plurality of”, “each”, and “any one” used in this application, “at least one” includes one, two, or more, “plurality of” includes two or more, “each” means each of a plurality of corresponding items, and “any one” means any one of a plurality of items. For example, a plurality of function controls include three function controls, “each” means each of the three function controls, and “any one” means any one of the three function controls, which may be the first function control, the second function control, or the third function control.

For ease of understanding of embodiments of this application, some terms in embodiments of this application are first described.

Virtual scene: The virtual scene is a virtual scene displayed (or provided) when an application runs on a terminal, that is, a scene displayed when a terminal runs a game, and is also referred to as a big world scene. The virtual scene is a simulated environment of the real world, a semi-simulated semi-fictional virtual environment, or a purely fictional virtual environment. The virtual scene may be any one of a two-dimensional virtual scene, a two-and-a-half-dimensional virtual scene, or a three-dimensional virtual scene, which is not limited in embodiments of this application. For example, the virtual scene includes the sky, the land, the ocean, and the like. The land includes environmental elements such as the desert and a city. A user can control a virtual object to move in the virtual scene. Certainly, the virtual scene further includes a virtual item, for example, a prop such as a thrown item, a building, or a vehicle. The virtual scene can further be used for simulating a real environment in different weathers, such as sunny, rainy, foggy, or dark weather. Various scene elements enhance diversity and realness of the virtual scene.

Virtual object: The virtual object is an object such as a movable virtual character in a virtual scene. The movable object may be a virtual person, a virtual animal, a cartoon person, or the like. The virtual object may be a virtual image for representing a user in the virtual scene. The virtual scene includes a plurality of virtual objects. Each virtual object has a shape and a volume in the virtual scene, and occupies some space in the virtual scene. In some embodiments, the virtual object is a character controlled by an operation performed on a client, or artificial intelligence (AI) set in a virtual environment by training, or a non-player character (NPC) set in the virtual scene. In some embodiments, the virtual object is a virtual character for competition in the virtual scene.

Virtual prop: The virtual prop is a prop used by a virtual object in a virtual scene. For example, the virtual prop is a virtual fishing net, a virtual compass, a virtual magic ball, or the like.

Information (including but not limited to object information and the like) and data (including but not limited to game data and the like) in this application are all authorized by a user or fully authorized by all parties, and collection, use, and processing of related data need to comply with relevant laws, regulations, and standards of relevant countries and regions. For example, the object information in this application is obtained under full authorization.

A function control display method provided in embodiments of this application can be performed by a terminal. In some embodiments, the terminal is a smartphone, a tablet computer, a notebook computer, a desktop computer, a smart speaker, a smartwatch, a smart voice interaction device, a smart household appliance, a vehicle-mounted terminal, or the like, but is not limited thereto.

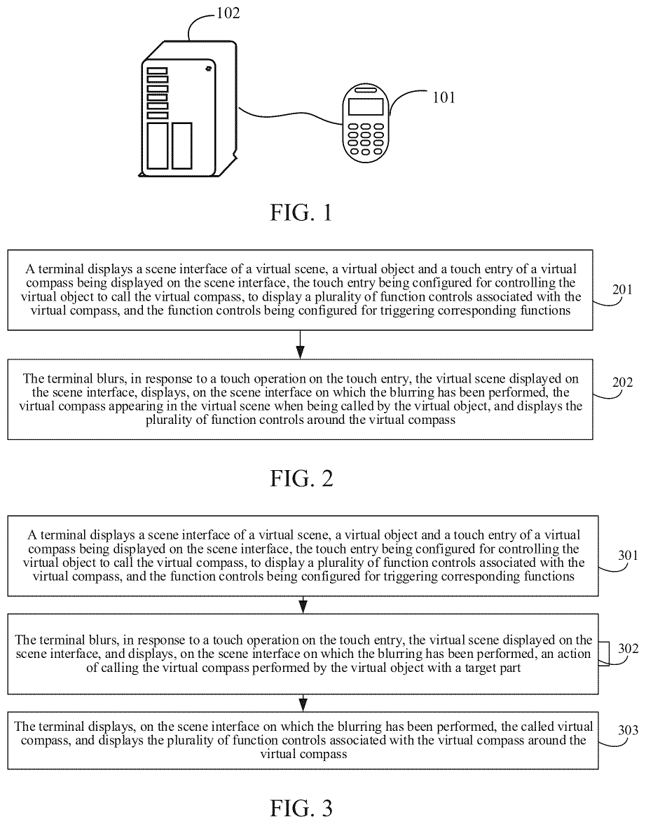

FIG. 1 is a schematic diagram of an implementation environment according to an embodiment of this application. Refer to FIG. 1. The implementation environment includes a terminal 101 and a server 102. The terminal device 101 is connected to the server 102 through a wired or wireless network.

An application for which the server 102 provides a service is installed on the terminal 101. The application supports display of a scene interface of a virtual scene. The terminal 101 can implement functions such as a game and message interaction by using the application. In some embodiments, the application is an application in an operating system of the terminal 101, or an application provided by a third party. For example, the application is a game application, and the game application has a game function. Certainly, the game application can further have another function, for example, a shopping function, a navigation function, and a message interaction function. The terminal 101 is a terminal used by any user. The first user can use the first terminal 101 to control a virtual object in the virtual scene to perform an activity, and the activity includes but is not limited to at least one of crawling, walking, running, jumping, driving, picking, shooting, attacking, and throwing. In some embodiments, different users respectively use different terminals to control virtual objects, and the virtual objects controlled by the different terminals are located in the same virtual scene. In this case, the different virtual objects can perform activities.

In some embodiments, the server 102 is an independent physical server, a server cluster including a plurality of physical servers or a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

In some embodiments, a computer program of the application is deployed on one server for execution, or deployed on a plurality of servers at one position for execution, or deployed on a plurality of servers distributed at a plurality of positions and connected via a communication network. The plurality of servers distributed at the plurality of positions and connected via the communication network can form a blockchain system.

The terminal 101 is configured to log in to the application based on a user identifier and interact with the server 102 by using the application to display the scene interface of the virtual scene, can blur the virtual scene displayed on the scene interface without interrupting a game, and can display a virtual compass and a plurality of associated function controls on the scene interface on which the blurring has been performed.

FIG. 2 is a flowchart of a function control display method according to an embodiment of this application. The method is performed by a terminal. As shown in FIG. 2, the method includes the following operations:
201: The terminal displays a scene interface of a virtual scene, a virtual object and a touch entry of a virtual compass being displayed on the scene interface, the touch entry being configured for controlling the virtual object to call (that is, activate, the same below) the virtual compass, to display a plurality of function controls associated with the virtual compass, and the function controls being configured for triggering corresponding functions.

In this embodiment of this application, the virtual compass is associated with the plurality of function controls. When the virtual object and the touch entry of the virtual compass are displayed on the scene interface, the plurality of function controls associated with the virtual compass are not displayed on the scene interface, so that few controls are displayed on the scene interface, to improve simplicity of the scene interface. In addition, the virtual compass can be called (that is, activated, the same below) in the virtual scene by using the touch entry of the virtual compass, to display the plurality of function controls associated with the virtual compass, so that the corresponding functions can be triggered subsequently by using the function controls.

The scene interface is a main interface, and the virtual scene, the virtual object located in the virtual scene, and the touch entry of the virtual compass can be displayed on the main interface. The virtual compass is a virtual prop in the virtual scene, and has a guiding function. The virtual compass has flexible implementations in different games. For example, the virtual compass is a virtual prop of any type, for example, a virtual map, a virtual globe, a virtual directional compass, a virtual navigator, a virtual magic stone, and a virtual magic wand. In different games, regardless of an implementation in which the virtual compass is represented, the virtual compass is associated with a plurality of function controls in the games, and subsequently, the virtual compass is called to call the associated plurality of function controls. The function control may be a control of any function. For example, the function control is a task control, a backpack control, a map control, or the like. The task control is configured for displaying a task interface through touch, to display a task of the virtual object. The backpack control is configured for displaying a backpack interface through touch, to display a prop that the virtual object has. The map control is configured for displaying a map interface through touch, to display a current position of the virtual object and a plurality of position points in the virtual scene.
202: The terminal blurs (that is, displays in a blurred manner, the same below) the virtual scene displayed on the scene interface in response to the touch operation on the touch entry, displays, on the scene interface on which the blurring has been performed, a scene in which the virtual compass appearing in the virtual scene when being activated by the virtual object, and displays the plurality of function controls around the virtual compass.

In this embodiment of this application, when the virtual scene displayed on the scene interface is blurred, a game still runs and is not terminated, that is, a process corresponding to the virtual scene, for example, a game process, is not interrupted. In a case that the game is not terminated, in a manner of blurring the virtual scene, the scene in which the virtual compass appearing in the virtual scene when being activated by the virtual object is displayed on the scene interface on which the blurring has been performed, and the plurality of function controls are displayed around the virtual compass, to improve clarity of the displayed virtual compass and function controls. In addition, the plurality of called function controls are displayed around the virtual compass, to simulate an effect of controlling the plurality of function controls by the virtual compass, so that corresponding functions can be subsequently triggered based on the function controls. It can be learned that when the function controls need to be used, because a process corresponding to the virtual scene, for example, a game process, does not need to be interrupted, interruption control resources of a system can be saved. In addition, because there is no need to frequently switch between function controls and a game scene, human-machine interaction resources of the system can be saved.

Based on the embodiment shown in FIG. 2, in an embodiment of this application, the virtual object can be controlled to perform an action to call the virtual compass. For a specific process, refer to the following embodiment.

FIG. 3 is a flowchart of a function control display method according to an embodiment of this application. The method is performed by a terminal. As shown in FIG. 3, the method includes the following operations:
301: The terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.

In a possible implementation, the touch entry of the virtual compass is displayed in a form of a virtual compass. In some embodiments, the virtual compass includes a plurality of states, and the touch entry of the virtual compass is displayed in a form of the virtual compass in a first state. The plurality of states include the first state and a second state.

In this embodiment of this application, when the virtual compass has a plurality of states, on the scene interface, the touch entry of the virtual compass is displayed in the form of the virtual compass in the first state. In this way, the touch entry of the virtual compass can be highlighted, to improve a display effect of the touch entry. In addition, when the virtual compass appears when being activated by the virtual object, the displayed virtual compass is in the second state, and this can highlight that the virtual compass is already activated and is being used, to highlight the display effect of using the virtual compass.

In some embodiments, the touch entry of the virtual compass is displayed in a form of a planar silhouette of the virtual compass in the first state, to improve the display effect of the touch entry.

In some embodiments, the first state is a folded state of the virtual compass, and the second state is an expanded state of the virtual compass. The folded state and the expanded state of the virtual compass are shown in FIG. 4. In this embodiment of this application, the touch entry of the virtual compass on the scene interface is displayed in a form of the virtual compass in the folded state. This can exhibit that the virtual compass is not started, to improve the display effect.

In a possible implementation, the touch entry of the virtual compass is displayed in a form of a button or in another form. In some embodiments, when the touch entry of the virtual compass is displayed in the form of a button, the button is filled with an image of the virtual compass in the first state. For example, the touch entry of the virtual compass is displayed in a form of a button, and the button is filled with a planar silhouette of the virtual compass in the first state.

In some embodiments, when the virtual scene is a three-dimensional virtual scene, the touch entry of the virtual compass is implemented by using a three-dimensional model. In other words, the touch entry is a three-dimensional touch entry.

In a possible implementation, pet information, specified task information, or an operation control is further displayed on the scene interface.

The pet information indicates a virtual sprite carried by the virtual object. In the virtual scene, the carried virtual sprite can be called by the virtual object, so that when the virtual object enters a battle state, the called virtual sprite can help the virtual object fight. The specified task information is configured for describing a specified task. In some embodiments, the virtual object corresponds to a plurality of tasks. When a task is specified for the virtual object, specified task information can be displayed on the scene interface for a user to view. The operation control is configured for controlling the virtual object to perform an action in the virtual scene. For example, the operation control includes a running control, a capturing control, and the like. The running control is configured for controlling the virtual object to run in the virtual scene, and the capturing control is configured for controlling the virtual object to capture a virtual sprite by using a virtual magic ball.

In this embodiment of this application, the plurality of function controls associated with the virtual compass include a task control, a backpack control, a map control, and the like. The plurality of function controls associated with the virtual compass are integrated in the virtual compass, and only the touch entry, the operation control, or other information of the virtual compass is displayed on the scene interface. In this way, content displayed on the scene interface can be reduced, to improve simplicity of the scene interface and improve a display effect of the scene interface.

In some embodiments, the operation control includes a touch wheel, and the touch wheel is configured for controlling the virtual object to move in the virtual scene. For example, the terminal controls, in response to a touch operation on the touch wheel, the virtual object to move in the virtual scene.

This embodiment of this application is described by using only an example in which the plurality of function controls associated with the virtual compass include the task control, the backpack control, and the map control. However, in another embodiment, another function control or a newly added function control may be associated with the virtual compass, and is integrated in the virtual compass.

In some embodiments, when the plurality of function controls associated with the virtual compass include the task control, the specified task information is displayed below the touch entry of the virtual compass.

The touch entry of the virtual compass can be displayed in any region on the scene interface. For example, the touch entry of the virtual compass is displayed at an upper right corner of the scene interface. The task control is configured for triggering to display a task interface, and the specified task information or other task information is displayed on the task interface. In this embodiment of this application, on the scene interface, the specified task information is displayed below the touch entry of the virtual compass, to provide a prompt about specific content of the task information, and provide a prompt for the user that the task interface can be triggered and displayed through the touch entry of the virtual compass, so as to improve the display effect of the scene interface and improve user experience.

In a possible implementation, if any function control associated with the virtual compass has a prompt message, a prompt identifier is displayed on the touch entry of the virtual compass displayed on the scene interface, and the prompt identifier indicates that the function control associated with the virtual compass has a prompt message.

The prompt identifier can be displayed in any form. For example, the prompt identifier is displayed in a red dot form.

In this embodiment of this application, because the plurality of function controls associated with the virtual compass is integrated in the touch entry of the virtual compass, the plurality of function controls associated with the virtual compass is not displayed on the scene interface. If any function control associated with the virtual compass has a prompt message, the prompt identifier is displayed on the touch entry of the virtual compass displayed on the scene interface, to provide a prompt that a function control has a prompt message. This is convenient for the user to trigger for viewing in a timely manner, and also avoids visual impact caused by excessive prompt identifiers displayed on the scene interface, to improve the display effect of the scene interface and the user experience.
302: The terminal blurs, in response to a touch operation on the touch entry, the virtual scene displayed on the scene interface, and displays, on the scene interface on which the blurring has been performed, an action of calling the virtual compass performed by the virtual object with a target part.

The target part of the virtual object is any part. For example, the target part of the virtual object is a hand, a head, or the like of the virtual object.

In this embodiment of this application, in response to the touch operation on a touch entry means that the user wants to control the virtual object to call the virtual compass, to display, on the scene interface, a plurality of function controls associated with the virtual compass. Therefore, the virtual scene displayed on the scene interface is blurred, so that when a game is not terminated, the action of calling the virtual compass performed by the virtual object with the target part is displayed on the scene interface on which the blurring has been performed, to exhibit an effect that the virtual object calls the virtual compass, so as to improve the display effect.

The action of calling the virtual compass is any action. For example, the action of calling the virtual compass is a hand-raising action or another action of the virtual object.
303: The terminal displays the called virtual compass on the scene interface on which the blurring has been performed, and displays the plurality of function controls associated with the virtual compass around the virtual compass.

In this embodiment of this application, the called virtual compass and the plurality of function controls associated with the virtual compass are displayed on the scene interface on which the blurring has been performed, and the target part of the virtual object points to the called virtual compass, to exhibit an effect that the virtual object calls the virtual compass and the function controls in the virtual scene and operates the virtual compass, so as to improve a display effect of a manner to appear of the virtual compass and the function controls and improve the user experience.

In a possible implementation, when the virtual scene is a three-dimensional virtual scene, the displayed virtual compass is a three-dimensional virtual compass, and the displayed function controls are three-dimensional function controls. For example, in the three-dimensional virtual scene, icons of the function control displayed on the scene interface are three-dimensional icons.

In this embodiment of this application, in the three-dimensional virtual scene, the three-dimensional virtual compass and the three-dimensional function controls are displayed in this manner, to exhibit that the three-dimensional function controls are content in the three-dimensional virtual scene rather than only controls displayed on the scene interface, so as to improve the display effect and the user experience.

In a possible implementation, operation 303 includes the following operations: displaying, in a case that the virtual object completes, with the target part, the action of calling the virtual compass, the called virtual compass and the plurality of function controls associated with the virtual compass on the scene interface on which the blurring has been performed; or displaying, in a process that the virtual object performs, with the target part, the action of calling the virtual compass, the called virtual compass and the plurality of function controls associated with the virtual compass on the scene interface on which the blurring has been performed; or displaying, in a process that the virtual object performs, with the target part, the action of calling the virtual compass, the virtual compass and the plurality of function controls associated with the virtual compass changing from being transparent to being clear on the scene interface on which the blurring has been performed; or displaying, in a case that the virtual object completes, with the target part, the action of calling the virtual compass, the virtual compass and the plurality of function controls associated with the virtual compass changing from being transparent to being clear on the scene interface on which the blurring has been performed.

In this embodiment of this application, in response to the touch operation on the touch entry of the virtual compass, the virtual object performs, with the target part, the action of calling the virtual compass. The virtual compass and the plurality of associated function controls can be displayed after the virtual object completes the action or displayed in a process that the virtual object performs the action, which is not limited in this application. In addition, the virtual compass and the plurality of function controls may be directly displayed, or the virtual compass and the plurality of function controls may be displayed in a manner of gradually becoming clear from being transparent, which is not limited in this application.

An example in which the virtual object calls, with the target part, the virtual compass and the plurality of function controls by performing the action of calling the virtual compass is used in this embodiment of this application. In another embodiment, the foregoing operation 302 and the foregoing operation 303 may not need to be performed, and another manner is used. In the another manner, the virtual scene displayed on the scene interface is blurred in response to the touch operation on the touch entry, the virtual compass appearing in the virtual scene when being activated by the virtual object is displayed on the scene interface on which the blurring has been performed, and the plurality of function controls are displayed around the virtual compass.

In addition, the virtual object calls the virtual compass and the plurality of function controls in the virtual scene in a manner of calling a virtual prop and not only controls displayed on the scene interface, so that the displayed function controls are highly integrated with the virtual scene, to improve the display effect of the function controls.

In this embodiment of this application, the user touches the touch entry of the virtual compass, the action of calling the virtual compass performed by the virtual object with the target part is displayed on the scene interface on which the blurring, and the called virtual compass and the plurality of function controls associated with the virtual compass are displayed on the scene interface on which the blurring, to exhibit the effect that the virtual compass and the function controls appear in the virtual scene when being activated by the virtual object, so that integration between the displayed function controls and the virtual scene is high, to improve the display effect of the manner to appear of the virtual compass and the function controls and improve the user experience.

Based on the embodiment shown in FIG. 2, in an embodiment of this application, a state change of the virtual compass can be displayed during the calling of the virtual compass. For a specific process, refer to the following embodiment.

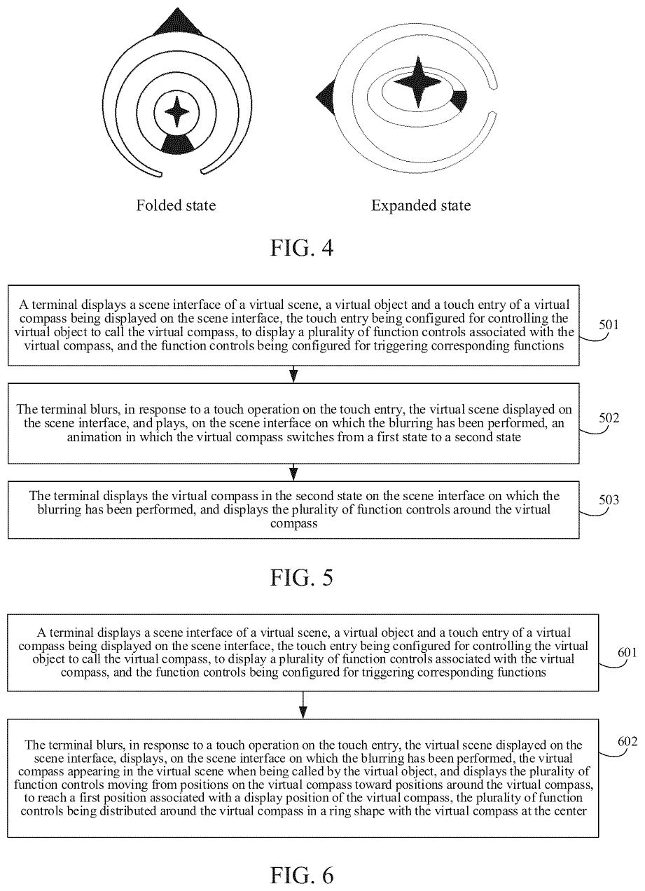

FIG. 5 is a flowchart of a function control display method according to an embodiment of this application. The method is performed by a terminal. As shown in FIG. 5, the method includes the following operations:
501: The terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.

In this embodiment of this application, of the touch entry is displayed in a form of the virtual compass in a first state. In some embodiments, the first state is a folded state of the virtual compass.
502: The terminal blurs, in response to a touch operation on the touch entry, the virtual scene displayed on the scene interface, and plays, on the scene interface on which the blurring has been performed, an animation in which the virtual compass switches from a first state to a second state.

In this embodiment of this application, the animation that is played in response to the touch operation on the touch entry and that is played on the scene interface on which the blurring has been performed can exhibit a process in which the virtual compass gradually switches from the first state to the second state, to improve a display effect during the calling of the virtual compass.

In a possible implementation, the first state is the folded state, and the second state is an expanded state, so that the animation in which the virtual compass is gradually expanded from being folded is played on the scene interface.

In a possible implementation, operation 502 includes the following operations: The terminal blurs the virtual scene displayed on the scene interface in response to the touch operation on the touch entry, obtains, based on an identifier of the virtual compass, the animation in which the virtual compass switches from the first state to the second state, and plays, on the scene interface on which the blurring has been performed, the animation in which the virtual compass switches from the first state to the second state.

The identifier of the virtual compass indicates the virtual compass. The animation in which the virtual compass switches from the first state to the second state may be obtained from an animation locally stored in the terminal, or the terminal interacts with a server to obtain, from the server, the animation in which the virtual compass switches from the first state to the second state. In this embodiment of this application, the terminal locally correspondingly stores the identifier of the virtual compass and the animation in which the virtual compass switches from the first state to the second state, so that the terminal can obtain the corresponding animation from a local storage based on the identifier of the virtual compass. Alternatively, the server correspondingly stores the identifier of the virtual compass and the animation in which the virtual compass switches from the first state to the second state, so that the server can obtain the corresponding animation from a local storage based on the identifier of the virtual compass, to further provide the animation for the terminal.

In a possible implementation, operation 502 includes the following operations: blurring, in response to the touch operation on the touch entry, the virtual scene displayed on the scene interface; canceling the display of the touch entry on the scene interface on which the blurring has been performed; and playing the animation in which the virtual compass switches from the first state to the second state.

In this embodiment of this application, in response to the touch operation on the touch entry, the display of the touch entry is canceled on the scene interface on which the blurring has been performed, so that only the animation in which the virtual compass switches from the first state to the second state is displayed and played on the scene interface on which the blurring has been performed. This avoids interference caused by excessive content displayed on the scene interface on which the blurring has been performed, and improves a display effect of the scene interface.
503: The terminal displays the virtual compass in the second state on the scene interface on which the blurring has been performed, and displays the plurality of function controls around the virtual compass.

In this embodiment of this application, the virtual compass being in the second state indicates that the virtual compass is being used. The terminal displays the virtual compass in the second state and the function controls on the scene interface on which the blurring has been performed, to indicate that the virtual compass is being used and exhibit that the virtual object is using the virtual compass in the virtual scene, so as to improve the display effect.

In a possible implementation, an example in which the second state is the expanded state of the virtual compass is used. Operation 503 includes the following operation: The terminal displays the virtual compass in the expanded state and the plurality of function controls on the scene interface on which the blurring has been performed, the virtual compass in the expanded state keeping rotating.

In this embodiment of this application, the virtual compass in the expanded state keeps rotating, to exhibit that the virtual compass is being used, so as to improve the display effect of the virtual compass.

In a possible implementation, an occasion for displaying the virtual compass in the second state and the plurality of function controls includes: when the playing of the animation is completed, displaying the virtual compass in the second state and the plurality of function controls; or displaying the plurality of function controls during the playing, on the scene interface, of the animation in which the virtual compass switches from the first state to the second state.

In this embodiment of this application, when the playing of the animation is completed, in other words, after the displayed virtual compass is converted from the first state into the second state, the virtual compass in the second state and the plurality of function controls are displayed. Alternatively, the animation in which the virtual compass is converted from the first state into the second state is a process in which the virtual compass displayed on the scene interface gradually changes. During the playing of the animation in which the virtual compass is converted from the first state into the second state, the plurality of function controls associated with the virtual compass are displayed, and the process of state conversion of the virtual compass can be displayed.

An example in which the animation of the virtual compass being converted from the first state into the second state is played is used in this embodiment of this application. However, in another embodiment, the foregoing operation 502 and the foregoing operation 503 may not need to be performed, and another manner is used. In the another manner, the virtual scene displayed on the scene interface is blurred in response to the touch operation on the touch entry, the virtual compass appearing in the virtual scene when being activated by the virtual object is displayed on the scene interface on which the blurring has been performed, and the plurality of function controls are displayed around the virtual compass.

In this embodiment of this application, the animation played on the scene interface in response to the touch operation on the touch entry can display the virtual compass gradually switching from the first state to the second state, to improve the display effect during the calling of the virtual compass.

Based on the embodiment shown in FIG. 2, in an embodiment of this application, an effect in which the function controls gradually spread around from the virtual compass for display can be exhibited during the calling of the virtual compass. For a specific process, refer to the following embodiment.

FIG. 6 is a flowchart of a function control display method according to an embodiment of this application. The method is performed by a terminal. As shown in FIG. 6, the method includes the following operations:
601: The terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.
602: The terminal blurs, in response to a touch operation on the touch entry, the virtual scene displayed on the scene interface, displays, on the scene interface on which the blurring has been performed, the virtual compass appearing in the virtual scene when being activated by the virtual object, and displays the plurality of function controls moving from positions on the virtual compass toward positions around the virtual compass, to reach a first position associated with a display position of the virtual compass, the plurality of function controls being distributed around the virtual compass in a ring shape with the virtual compass at the center.

In this embodiment of this application, in response to the touch operation on the touch entry, the virtual compass appearing in the virtual scene when being activated by the virtual object is displayed on the scene interface on which the blurring has been performed. In addition, during the calling of the virtual compass, the following is displayed: The plurality of function controls associated with the virtual compass gradually move from positions on the virtual compass toward positions around the virtual compass, to reach the first position associated with the display position. In this way, the effect that the virtual compass provides the plurality of associated function controls is exhibited, to ensure the display effect of the calling of the virtual compass and the function controls.

The display position of the virtual compass is any position on the scene interface. For example, the display position of the virtual compass is a central position on the scene interface. The first position associated with the display position of the virtual compass is a position in a preset correspondence with the display position. For example, the first position is a position that is in an annular region with the display position at the center and that is spaced apart from the display position by a target distance, and the target distance is any distance. In some embodiments, the plurality of function controls associated with the virtual compass is evenly distributed in an annular region with the virtual compass at the center and spaced from the display position of the virtual compass by a target distance.

In this embodiment of this application, during the calling of the virtual compass, the function controls gradually spread around from the virtual compass for display. However, in another embodiment, the foregoing operation 602 may not need to be performed, and another manner is used. In the another manner, the virtual scene on the scene interface is blurred in response to the touch operation on the touch entry, the virtual compass appearing in the virtual scene when being activated by the virtual object is displayed on the scene interface on which the blurring has been performed, and the plurality of function controls are displayed around the virtual compass.

In this embodiment of this application, in response to the touch operation on the touch entry, the virtual scene displayed on the scene interface is blurred, the virtual compass appearing in the virtual scene when being activated by the virtual object is displayed on the scene interface on which the blurring has been performed. In addition, during the calling of the virtual compass, the following is displayed: The plurality of function controls associated with the virtual compass gradually move from positions on the virtual compass toward positions around the virtual compass, to reach the first position associated with the display position of the virtual compass, and the function controls are distributed around the virtual compass in a ring shape with the virtual compass at the center. In this way, the effect that the virtual compass provides the associated function controls is exhibited, to ensure the display effect of the calling of the virtual compass and the function controls.

Based on the embodiment shown in FIG. 2, in an embodiment of this application, the virtual compass has a guiding function. The virtual compass includes a plurality of components, and different components can indicate different directions or positions. For a specific process, refer to the following embodiment.

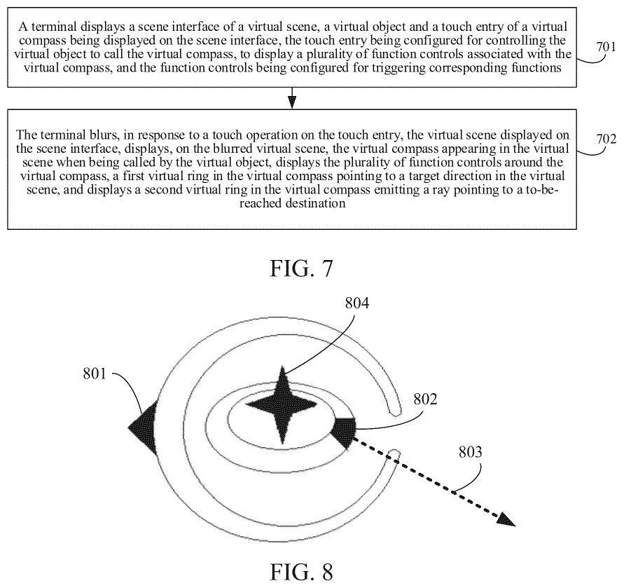

FIG. 7 is a flowchart of a function control display method according to an embodiment of this application. The method is performed by a terminal. As shown in FIG. 7, the method includes the following operations:
701: The terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.
702: The terminal blurs, in response to a touch operation on the touch entry, the virtual scene displayed on the scene interface, displays, on the blurred virtual scene, the virtual compass appearing in the virtual scene when being activated by the virtual object, displays the plurality of function controls around the virtual compass, a first virtual ring of the virtual compass pointing to a target direction in the virtual scene, and displays a second virtual ring of the virtual compass emitting a ray pointing to a to-be-reached destination.

In this embodiment of this application, the virtual compass is formed by the first virtual ring and the second virtual ring. The virtual compass has a guiding function. When the virtual compass is displayed on the virtual scene on which the blurring has been performed, the first virtual ring and the second virtual ring included in the virtual compass can point to different directions or positions, and the second virtual ring can provide directional guidance for a user by emitting a ray. In this way, the user can learn a current orientation of the virtual object and a direction of the to-be-reached destination, to improve a guiding effect and user experience.

The target direction is any direction in the virtual scene. For example, the target direction is north, south, or the like in the virtual scene. The ray emitted by the second virtual ring can be displayed in any form. For example, a color of the ray is displayed as yellow, red, or another color, or the ray is displayed in another manner. The to-be-reached destination is any position in the virtual scene. For example, the destination is any position selected by the user from the virtual scene, or the destination is a position corresponding to a task specified by the user, in other words, a position that the virtual object needs to arrive at when completing a specified task.

In a possible implementation, the first virtual ring emits a ray pointing to the target direction, and the rays emitted by the first virtual ring and the second virtual ring are displayed in different forms. In this embodiment of this application, both the first virtual ring and the second virtual ring can emit the rays to indicate directions or positions for the user to view, so that the user experience can be improved.

In a possible implementation, the first virtual ring includes a direction indication region, and the direction indication region projects out of other parts of the first virtual ring, so that the user views a direction indicated by the direction indication region of the first virtual ring. The second virtual ring includes a ray emitting region, and the ray emitting region is configured for emitting the ray pointing to the destination.

For example, when the virtual compass and the function controls appear when being activated by the virtual object, the virtual compass displayed on the scene interface is shown in FIG. 8. A direction indication region 801 of the first virtual ring of the virtual compass points to north in the virtual scene, a ray emitting region 802 of the second virtual ring emits a ray 803, and the ray 803 points to a position that the virtual object needs to arrive at when a specified task is completed.

In some embodiments, the virtual compass further includes a virtual component, and the virtual component can be displayed in any form. For example, the virtual component is displayed in a form of a rhombus or a five-pointed star. When the virtual compass and the function controls appear when being activated by the virtual object, the virtual compass displayed on the scene interface is shown in FIG. 8. A virtual component 804 of the virtual compass is in a rotating state, to indicate that the virtual compass is being used, in other words, to indicate that the virtual compass is in effect.

In a possible implementation, operation 702 includes the following operations: blurring, in response to the touch operation on the touch entry, the virtual scene displayed on the scene interface; displaying, on the virtual scene on which the blurring has been performed, the virtual compass appearing when being activated by the virtual object; displaying the plurality of function controls the virtual compass, the first virtual ring of the virtual compass pointing to the target direction in the virtual scene; determining, based on a current position of the virtual object and the destination, a ray direction pointing from the current position of the virtual object to the destination; and displaying the ray emitted by the second virtual ring along the ray direction, the ray pointing to the destination.

An example in which the second virtual ring emits the ray pointing to the destination is used for description in this embodiment of this application. However, in another embodiment, the foregoing operation 702 does not need to be performed, and another manner is used. In the another manner, the virtual scene displayed on the scene interface is blurred in response to the touch operation on the touch entry, the virtual compass appearing when being activated by the virtual object is displayed in the blurred virtual scene, and the plurality of function controls are displayed around the virtual compass. The first virtual ring points to the target direction in the virtual scene, and the second virtual ring points to the to-be-reached destination.

An example in which the virtual compass includes the first virtual ring and the second virtual ring is used in this embodiment of this application, and when the virtual compass is displayed, the first virtual ring and the second virtual ring can point to directions or positions. However, in another embodiment, the foregoing operation 702 may not need to be performed, and another manner is used. In the another manner, the virtual scene on the scene interface is blurred in response to the touch operation on the touch entry, the virtual compass appearing in the virtual scene when being activated by the virtual object is displayed on the scene interface on which the blurring has been performed, and the plurality of function controls are displayed around the virtual compass.

In this embodiment of this application, the virtual compass has the guiding function. When the virtual compass is displayed on the scene interface on which the blurring has been performed, the first virtual ring and the second virtual ring included in the virtual compass can point to different directions or positions, to provide directional guidance for the user, so that the user learns of the current orientation of the virtual object and the direction of the to-be-reached destination, to improve the user experience.

Based on the embodiment shown in FIG. 2, in an embodiment of this application, in a process of controlling the virtual object to call the virtual compass, a position of a virtual camera is adjusted, to adjust a photographed virtual scene, to ensure continuity of the virtual scene displayed on the scene interface. For a specific process, refer to the following embodiment.

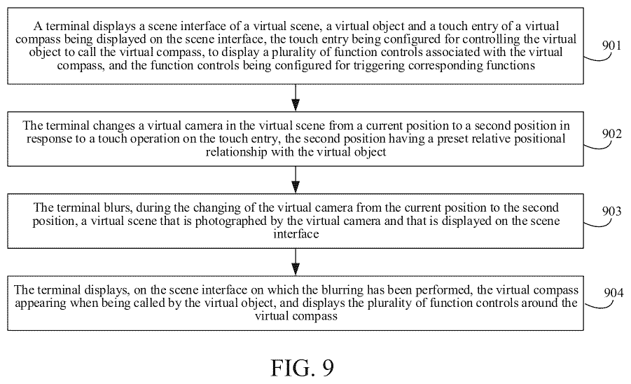

FIG. 9 is a flowchart of a function control display method according to an embodiment of this application. The method is performed by a terminal. As shown in FIG. 9, the method includes the following operations:
901: The terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.
902: The terminal changes a virtual camera in the virtual scene from a current position to a second position in response to a touch operation on the touch entry, the second position having a preset relative positional relationship with the virtual object.

In this embodiment of this application, the virtual camera is configured to photograph a virtual scene, so that the virtual scene photographed by the virtual camera is displayed on the scene interface. When the called virtual compass is displayed on the scene interface, the position of the virtual camera has a preset relative positional relationship with the virtual object. To be specific, each time the virtual compass is called, a relative positional relationship between the position of the virtual camera and the virtual object keeps unchanged, so that the called virtual compass can be displayed at a fixed camera perspective, to ensure a display effect.

The preset relative positional relationship is any relative positional relationship. For example, the second position is a fixed position at the rear of the virtual object, or a fixed position at the left rear of the virtual object.

In this embodiment of this application, when the touch operation on the touch entry is detected, the current position of the virtual camera may be any position. For example, the current position of the virtual object is right in front of the virtual object, and in this case, a front side of the virtual object is displayed on the scene interface. Therefore, the virtual camera in the virtual scene is changed from the current position to the second position, so that the called virtual compass can be displayed at a fixed camera perspective, to ensure the display effect.

In a possible implementation, the second position is represented by

coordinates in the virtual scene, and in this case, a process of determining the second position includes the following operation: determining the second position based on the position of the virtual object and the preset relative positional relationship.

In this embodiment of this application, the position of the virtual object is represented by the coordinates in the virtual scene, and the preset relative positional relationship can indicate the relative positional relationship between the second position and the position of the virtual object. Therefore, based on the position of the virtual object, the second position represented by the coordinates in the virtual scene can be determined with reference to the preset relative positional relationship.

In some embodiments, the preset relative positional relationship is an offset of the second position relative to the position of the virtual object. Based on the position of the virtual object, the offset of the second position relative to the position of the virtual object is increased to obtain the second position. For example, the position of the virtual object includes coordinates of an X axis, a Y axis, and a Z axis in a coordinate system, and the preset relative positional relationship includes offsets of the X axis, the Y axis, and the Z axis in the coordinate system. The position of the virtual object is offset on the X axis, the Y axis, and the Z axis based on the offsets included in the preset relative positional relationship. A position obtained through the offset is the second position, and the second position is a homing position of the camera.

In some embodiments, the process of determining the second position includes the following operation: determining the second position based on the position of the virtual object, an orientation of the virtual object, and the preset relative positional relationship.

The orientation of the virtual object indicates a direction that the virtual object faces. In this embodiment of this application, the second position is determined based on the position of the virtual object, the orientation of the virtual object, and the preset relative positional relationship, to ensure that the virtual camera can photograph the virtual object after the virtual camera changes to the second position, so as to ensure accuracy of content displayed on the scene interface after the position is changed.

In a possible implementation, a process of changing the position of the virtual object includes the following operation: changing the virtual camera in the virtual scene from the current position to the second position based on a rotation speed of the virtual camera.

The rotation speed is any speed. In some embodiments, the virtual camera in the virtual scene is changed from the current position to the second position based on the rotation speed of the virtual camera by using an interpolation algorithm (Lerp). In this embodiment of this application, rotation is performed at the rotation speed, to ensure a display effect of the virtual scene photographed by the virtual camera during the rotation.

In a possible implementation, before the virtual camera in the virtual scene changes from the current position to the second position, whether the virtual camera can change to the second position needs to be determined. To be specific, a process of determining whether the virtual camera can change to the second position includes the following operations: determining, based on a distance between the second position and the position of the virtual object, whether the virtual camera can change to the second position; and determining, when the distance is greater than a threshold, that the virtual camera can change to the second position; or determining, when the distance is not greater than a threshold, that the virtual camera cannot change to the second position.

The threshold is any value. In this embodiment of this application, the terminal determines, in response to the touch operation on the touch entry, whether the virtual camera can change to the second position, and changes the virtual camera in the virtual scene from the current position to the second position only when it is determined that the virtual camera can change to the second position. However, when it is determined that the virtual camera cannot change to the second position, operation 902 to operation 904 are not performed, and a prompt message is displayed instead, the prompt message indicating that the virtual compass cannot be called.
903: The terminal blurs, during the changing of the virtual camera from the current position to the second position, the virtual scene that is photographed by the virtual camera and that is displayed on the scene interface.

In this embodiment of this application, during the changing of the virtual camera from the current position to the second position, the virtual camera further photographs the virtual scene, and displays the photographed virtual scene in a blurred manner, to exhibit an effect that the position of the virtual camera gradually changes, so as to improve the display effect and ensure clarity of the virtual compass and the function controls that are displayed subsequently.

In a possible implementation, during the changing of the virtual camera from the current position to the second position, a photography perspective of the virtual camera is always oriented to the position of the virtual object, and during the changing of the virtual camera from the current position to the second position, the virtual object is always displayed in the virtual scene photographed by the virtual camera.
904: The terminal displays, on the scene interface on which the blurring has been performed, the virtual compass appearing when being activated by the virtual object, and displays the plurality of function controls around the virtual compass.

In a possible implementation, in the process in which the virtual camera changes from the current position to the second position, the photographed virtual scene is displayed in a blurred manner. The photographed virtual scene includes an image of the virtual compass and the plurality of function controls appearing in the virtual scene when being activated by the virtual object.

An example in which the position of the virtual camera in the virtual scene is adjusted is used for description in this embodiment of this application. However, in another embodiment, the foregoing operation 902 to the foregoing operation 904 may not need to be performed, and another manner is used. In the another manner, the virtual scene displayed on the scene interface is blurred in response to the touch operation on the touch entry, the virtual compass appearing in the virtual scene when being activated by the virtual object is displayed on the scene interface on which the blurring has been performed, and the plurality of function controls are displayed around the virtual compass.

In this embodiment of this application, when the touch operation on the touch entry is detected, the current position of the virtual camera may be any position. Therefore, the virtual camera in the virtual scene is changed from the current position to the second position, so that the called virtual compass can be displayed at a fixed camera perspective, to ensure the display effect.

For example, the virtual scene displayed on the scene interface is photographed by the virtual camera in the virtual scene from a third-person perspective. When the virtual object and the touch entry of the virtual compass are displayed on the scene interface, the virtual object displayed on the scene interface is located at the center of the scene interface. In this case, a user can adjust the photography perspective of the virtual camera, to adjust an image displayed on the scene interface. For example, the front side of the virtual object, a virtual environment around the virtual object, and the touch entry are displayed on the scene interface. In response to the touch operation on the touch entry of the virtual compass, the virtual camera rotates from the current position to a position behind and above the head of the virtual object, and the virtual scene photographed by the virtual camera is displayed in a blurred manner. In this case, a back side of the virtual object is displayed on the scene interface on which the blurring has been performed, the virtual object is displayed in an enlarged manner, and the virtual compass and the plurality of function controls appearing when being activated by the virtual object are displayed.

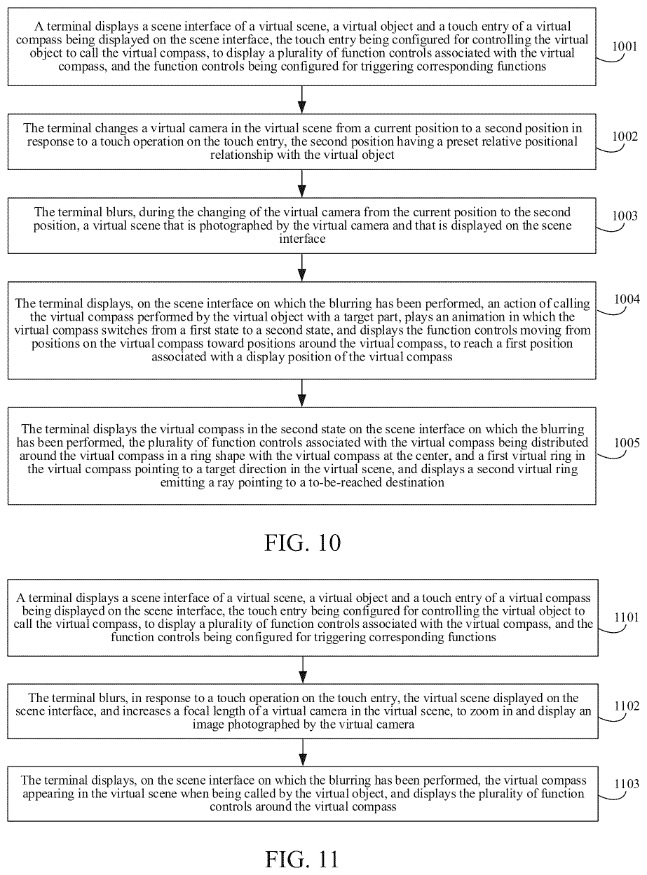

The foregoing embodiments shown in FIG. 2 to FIG. 9 can be randomly combined. A combination of the foregoing embodiments shown in FIG. 2 to FIG. 9 is used as an example. As shown in FIG. 10, a function control display method includes the following operations:
1001: A terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.
1002: The terminal changes a virtual camera in the virtual scene from a current position to a second position in response to a touch operation on the touch entry, the second position having a preset relative positional relationship with the virtual object.
1003: The terminal blurs, during the changing of the virtual camera from the current position to the second position, a virtual scene that is photographed by the virtual camera and that is displayed on the scene interface.
1004: The terminal displays, on the scene interface on which the blurring has been performed, an action of calling the virtual compass performed by the virtual object with a target part, plays an animation in which the virtual compass switches from a first state to a second state, and displays the function controls moving from positions on the virtual compass toward positions around the virtual compass, to reach a first position associated with a display position of the virtual compass.
1005: The terminal displays the virtual compass in the second state on the scene interface on which the blurring has been performed, the plurality of function controls associated with the virtual compass being distributed around the virtual compass in a ring shape with the virtual compass at the center, and a first virtual ring of the virtual compass pointing to a target direction in the virtual scene, and displays a second virtual ring emitting a ray pointing to a to-be-reached destination.

Based on the embodiment shown in FIG. 2, in an embodiment of this application, in a process of controlling the virtual object to call the virtual compass, a focal length of the virtual camera is increased, to zoom in and display an image photographed by the virtual camera. For a specific process, refer to the following embodiment.

FIG. 11 is a flowchart of a function control display method according to an embodiment of this application. The method is performed by a terminal. As shown in FIG. 11, the method includes the following operations:
1101: The terminal displays a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.
1102: The terminal blurs, in response to a touch operation on the touch entry, the virtual scene displayed on the scene interface, and increases a focal length of a virtual camera in the virtual scene, to zoom in and display an image photographed by the virtual camera.

The virtual camera is configured to photograph a virtual scene, so that the virtual scene photographed by the virtual camera is displayed on the scene interface. The focal length of the virtual camera is for adjusting a distance of the image photographed by the virtual camera. An example in which the virtual camera photographs a virtual object is used. A larger focal length of the virtual camera and a closer photographed virtual object indicate a larger photographed virtual object displayed on the scene interface. A smaller focal length of the virtual camera and a farther photographed virtual object indicate a smaller photographed virtual object displayed on the scene interface.

In this embodiment of this application, when the called virtual compass is displayed on the scene interface, the focal length of the virtual camera in the virtual scene is increased, to zoom in and display the image photographed by the virtual camera, so that the virtual scene or the virtual object in the photographed image can be zoomed in for display, to make the photographed image clearer, so as to improve a display effect of the photographed image.
1103: The terminal displays, on the scene interface on which the blurring has been performed, the virtual compass appearing in the virtual scene when being activated by the virtual object, and displays the plurality of function controls around the virtual compass.

In the solutions provided in the foregoing embodiments shown in FIG. 2 to FIG. 11 of this application, the virtual compass is used as a medium, the plurality of function controls are integrated in the touch entry of the virtual compass. Through the touch entry of the virtual compass, the virtual compass and the function controls appearing in the virtual scene when being activated by the virtual object is displayed, by blurring the virtual scene, on the scene interface on which the blurring has been performed, so that when the virtual compass and the function controls appear when being called, the user can still view the blurred virtual scene. This ensures that a process of a game is not interrupted when the calling of the virtual compass and the function controls is displayed, and also avoids visual impact brought by the virtual scene, to further ensure clarity of the virtual compass and the function controls that are displayed. In addition, the plurality of called function controls are displayed around the virtual compass, to simulate an effect that the virtual compass controls the plurality of function controls. In this way, simplicity of the scene interface is ensured, and a need of switching the scene interface to display the function controls is eliminated. This reduces quantities of human-machine interactions and interruptions, and saves system resources. In addition, this avoids visual impact caused by the switching of the interface, reduces a feeling of interruption caused by the switching of the interface, and ensures continuity of the game. In this way, continuity of the displayed virtual scene can be ensured, so that the user can be immersed in the displayed virtual scene, to improve the user experience.

In this embodiment of this application, when the called virtual compass is displayed on the scene interface, the focal length of the virtual camera in the virtual scene is increased, to zoom in and display the image photographed by the virtual camera, so that the virtual scene or the virtual object in the photographed image can be zoomed in for display, to make the photographed image clearer, so as to improve the display effect of the photographed image.

Based on the foregoing embodiments shown in FIG. 2 to FIG. 11, in an embodiment of this application, when the function controls are displayed on the scene interface on which the blurring has been performed, the displayed function controls sway with a wind field special effect. In a possible implementation, the method further includes the following operations: displaying the wind field special effect on the scene interface on which the blurring has been performed; and displaying, during the display of the wind field special effect, the function controls swaying with the wind field special effect on the scene interface on which the blurring has been performed.

The wind field special effect is for simulating an effect of wind blowing in the virtual scene. In this embodiment of this application, when the virtual compass and the function controls are displayed on the scene interface on which the blurring has been performed and when the wind field special effect is displayed on the scene interface, the function controls swaying with the wind field special effect is displayed, to exhibit that the function controls are controls called by the virtual object in the virtual scene rather than merely controls displayed on the scene interface, so as to improve the display effect of the scene interface.

In some embodiments, when the wind field special effect is displayed on the scene interface on which the blurring has been performed, a swaying amplitude of the function controls is determined based on a wind parameter corresponding to the wind field special effect, and during the display of the wind field special effect, the function controls swaying based on the swaying amplitude is displayed on the scene interface.

The wind parameter indicates a wind magnitude of the wind blowing in the virtual scene. A larger wind parameter indicates a larger swaying amplitude of the function controls, and a smaller wind parameter indicates a smaller swaying amplitude of the function controls. In this embodiment of this application, the swaying amplitude of the function controls is determined based on the wind parameter corresponding to the wind field special effect, to control, based on the swaying amplitude, the function controls to sway, so as to exhibit an effect of the swaying of the function controls due to the wind blowing in the virtual scene, and simulate a scenario in which an object is blown by wind in a real scenario, thereby improving the display effect.

Based on the foregoing embodiments shown in FIG. 2 to FIG. 11, in an embodiment of this application, when the plurality of function controls are displayed on the scene interface on which the blurring has been performed, the displayed function controls sway with a posture change of a local device. In a possible implementation, the method further includes the following operation: The terminal displays, in response to the posture change of the local device being detected, a display angle of the plurality of function controls varying with the posture change of the local device in the virtual scene on which the blurring has been performed.

The display angle of the function controls is for representing a display form of the function controls. A posture of the local device is a posture of the terminal, and the posture of the terminal includes a horizontal posture, a tilted posture, and the like.

In this embodiment of this application, when detecting that the posture of the terminal changes, the terminal adjusts the display angle of the function controls displayed on the scene interface, to exhibit that the function controls change with the change of the terminal, so as to exhibit that the displayed function controls have a gyroscope effect, thereby improving the display effect and the user experience.

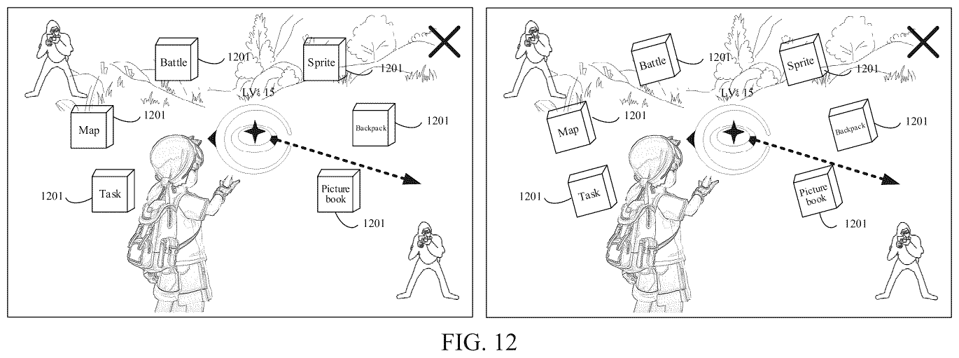

For example, when the user holds the terminal by a hand and controls the terminal to tilt, the terminal displays, on the scene interface on which the blurring has been performed, that the display angle of the function controls changes, to exhibit an effect that the function controls rotate as the terminal tilts. For another example, when a user holds a terminal by a hand, as shown in the left section in FIG. 12, the terminal displays, on a scene interface on which blurring has been performed, a plurality of function controls 1201 being in a vertical state. When the user holds, by the hand, the terminal to tilt leftward, as shown in the right section in FIG. 12, the terminal displays, on the scene interface on which the blurring has been performed, the plurality of function controls 1201 also tilting leftward.

In some embodiments, the terminal obtains posture information of the terminal every target duration; compares the obtained posture information with previously obtained posture information to obtain a posture change parameter; if the posture change parameter indicates a posture change of the terminal, determines a rotation angle of the function controls based on the posture change parameter; rotates the function controls based on the rotation angle; and displays the function controls being rotated from the current display angle to a display angle after the rotation.

The target duration is any duration, for example, the target duration is 0.2 second. The posture information indicates the posture of the terminal, and the posture change parameter indicates a difference between two pieces of posture information. The rotation angle of the function controls is an amplitude by which the display angle of the function controls needs to be controlled to change when the posture of the terminal changes this time. In some embodiments, the rotation angle is a positive angle value or a negative angle value. The positive angle value indicates that the function controls are controlled to rotate rightward, and the negative angle value indicates that the function controls are controlled to rotate leftward. In some embodiments, the terminal is configured with a gyroscope sensor, and the terminal obtains the posture information of the terminal by using the gyroscope sensor.

In this embodiment of this application, when the posture change parameter indicates the posture change of the terminal, the rotation angle of the function controls is determined based on the posture change parameter, and rotation of the function controls is displayed based on the determined rotation angle, so that the change in the display angle of the function controls matches the posture change of the terminal, to ensure the display effect of the function controls and improve the user experience.

For example, the posture information is a tilt value. The terminal obtains a tilt value of the terminal at a current moment through a native interface, compares the tilt value at the current moment with a tilt value that is previously obtained, and if it is determined that the tilt value of the terminal changes, updates, in Tick (a category), a relative rotation angle in a static mesh component corresponding to the function controls, so that the function controls rotate. In this embodiment of this application, the function controls rotate only about the X axis of a coordinate system in the virtual scene, and rotation on the Z and Y axes is locked. The X axis is a direction perpendicular to a terminal screen.

In some embodiments, a process of determining the rotation angle of the function controls based on the posture change parameter includes the following operations: determining a product of the posture change parameter and a unit rotation angle as the rotation angle of the function controls; or querying a correspondence between the posture change parameter and the rotation angle based on the posture change parameter, and determining the rotation angle corresponding to the posture change parameter as the rotation angle of the function controls.

The unit rotation angle is a rotation angle of the function controls in a case of the unit posture change parameter. The product of the posture change parameter and the unit rotation angle is determined as the rotation angle of the function controls, to exhibit that a larger amplitude of the posture change of the terminal indicates a larger rotation amplitude of the function controls.

The correspondence between the posture change parameter and the rotation angle includes a rotation angle corresponding to each posture change parameter.

In some embodiments, a process of determining whether the posture of the terminal changes includes the following operations: determining, when the posture change parameter is greater than a target threshold, that the posture of the terminal changes; or determining, when the posture change parameter is not greater than a target threshold, that the posture of the terminal does not change, the target threshold being any value.

In some embodiments, the display angle of the function controls is within an angle range. When the function controls are controlled to rotate, the display angle of the function controls can change only within the angle range. For example, in a process of controlling the function controls to rotate to increase the display angle of the function controls, in response to current a display angle of the function controls being a maximum boundary value within the angle range, the function controls are not controlled to rotate. In a process of controlling the function controls to rotate to reduce the display angle of the function controls, in response to the current display angle of the function control being a minimum boundary value within the angle range, the function controls are not controlled to rotate.

In this embodiment of this application, the angle range is set for the display angle of the function controls, to prevent the function controls from being displayed at a display angle that is inconvenient for the user to view, so as to ensure the display effect of the function controls.

Based on the foregoing embodiments shown in FIG. 2 to FIG. 11, in an embodiment of this application, when the plurality of function controls are displayed on the scene interface on which the blurring has been performed, the photography perspective of the virtual camera varies with the posture change of the local device. In a possible implementation, the method further includes the following operation: The terminal adjusts, in response to the posture change of the local device being detected, the photography perspective of the virtual camera in the virtual scene to vary with the posture change of the local device, to display the virtual scene photographed by the virtual camera in the blurred virtual scene.

In this embodiment of this application, the virtual camera photographs the virtual scene at the photography perspective, and when the photography perspective changes, the image photographed by the virtual camera changes. When detecting that the posture of the terminal changes, the terminal adjusts the photography perspective of the virtual camera in the virtual scene, to exhibit that the photography perspective of the virtual camera varies with the posture change of the local device. In other words, the imaged displayed on the scene interface on which the blurring has been performed varies with the posture change of the local device, to exhibit that the displayed function controls have the gyroscope effect, so as to improve the display effect and the user experience.

For example, when the user holds the terminal by the hand and controls the terminal to tilt, the virtual scene displayed by the terminal on the scene interface on which the blurring has been performed changes, to exhibit an effect that the virtual camera adjusts the photography perspective as the terminal tilts.

In some embodiments, a process of adjusting the photography perspective of the virtual camera in the virtual scene includes the following operations: The terminal rotates, in response to the posture change of the local device being detected, the virtual camera with the position of the virtual camera in the virtual scene at the center, so that the photography perspective of the virtual camera varies with the posture change of the local device, to display the virtual scene photographed by the virtual camera in the blurred virtual scene.

In this embodiment of this application, the image displayed on the scene interface is an image photographed by the virtual camera. In response to detecting that the posture of the terminal changes, to keep the position of the virtual camera in the virtual scene unchanged, the virtual camera is rotated, a photography direction of the virtual camera is adjusted, to adjust the photography perspective of the virtual camera. In this way, the photography perspective of the virtual camera varies with the posture change of the local device, and the image displayed on the scene interface on which the blurring has been performed changes with the posture change of the local device, to exhibit that the displayed function controls have the gyroscope effect, so as to improve the display effect and the user experience.

In some embodiments, the terminal obtains posture information of the terminal every target duration; compares the obtained posture information with previously obtained posture information to obtain a posture change parameter; if the posture change parameter indicates a posture change of the terminal, determines a rotation angle of the virtual camera based on the posture change parameter; rotates the virtual camera based on the rotation angle of the virtual camera, so that the photography perspective of the virtual camera varies with the posture change of the local device, to display the virtual scene photographed by the virtual camera in the blurred virtual scene.

The posture information indicates the posture of the terminal, and the posture change parameter indicates a difference between two pieces of posture information. The rotation angle of the virtual camera is an angle by which the virtual camera needs to be controlled to rotate when the posture of the terminal changes this time.

In this embodiment of this application, if the posture change parameter indicates the posture change of the terminal, the rotation angle of the virtual camera is determined based on the posture change parameter, and the virtual camera is rotated based on the rotation angle of the virtual camera, so that the photography perspective of the virtual camera changes and matches the posture of the terminal, to ensure the display effect of the scene interface and improve the user experience.

Based on the foregoing embodiments shown in FIG. 2 to FIG. 11, in an embodiment of this application, when the function controls are displayed on the scene interface, the touch operation can further be performed on the displayed virtual compass or the function controls. In a possible implementation, the method further includes the following operations: displaying in response to the touch operation on the function controls, a function interface corresponding to the function controls; or displaying, in response to the touch operation on the virtual compass in the scene interface, object information corresponding to the virtual object.

The function controls are configured for triggering the corresponding functions. For example, the function control includes a task control and a backpack control. A user clicks/taps on the task control to display a task interface, and task information of each task of the virtual object are displayed on the task interface. The user clicks/taps the backpack control to display a backpack interface, and a virtual prop owned by the virtual object is display on the backpack interface. The virtual compass is configured to trigger the display of the object information corresponding to the virtual object. The object information is configured for describing the virtual object. For example, the object information includes a level of the virtual object, an object name, a quantity of owned virtual sprites, a level of a virtual sprite, obtained rewards, and the like.

In this embodiment of this application, when the function controls and the virtual compass are displayed, the function controls or the virtual compass is triggered, so that a corresponding interface or information can be presented for the user to view. In other words, the virtual compass can alternatively be triggered as a control to display corresponding information, so as to enrich variety of control display, and further improve the display effect.

In some embodiments, a process of displaying the object information of the virtual object includes the following operations: displaying, in response to the touch operation on the virtual compass, the virtual object and the virtual compass moving in a first direction on the scene interface on which the blurring has been performed; and displaying, while keeping the virtual object and the virtual compass displayed, the object information of the virtual object in a first region on the scene interface on which the blurring has been performed, the first region being located in a second direction of the virtual compass, and the first direction being opposite to the second direction.

The first direction is any direction. For example, if the first direction is a leftward direction, the second direction is a rightward direction. For example, in response to the touch operation on the virtual compass, the display of the function controls is canceled, and a lens of the virtual camera in the virtual scene is translated leftward and pushed, so that the virtual object and the virtual compass moving leftward are exhibited in the image photographed by the virtual camera and displayed on the scene interface, to display the object information of the virtual object in a right region on the scene interface.

In some embodiments, in response to a close operation on the object information of the virtual object, the object information of the virtual object displayed in the first region on the scene interface on which the blurring has been performed is canceled, the virtual object and the virtual compass moving toward the second direction to an original position is displayed on the scene interface on which the blurring has been performed, and the plurality of function controls are displayed.

The virtual scene photographed by the virtual camera is displayed on the scene interface. When the virtual compass and the function control are displayed on the scene interface, the object information or the function interface corresponding to the triggered function controls is displayed in response to the touch operation on the virtual compass or the function controls. These are also displayed based on the virtual camera. In this embodiment of this application, a plurality of state parameters are configured for the virtual object, so that when object information or different function interfaces are displayed, the virtual camera is controlled based on a corresponding state parameter, to ensure a display effect of the displayed interface. In some embodiments, the plurality of state parameters are stored in a state machine of the virtual camera. In some embodiments, the state parameter includes an offset, a speed, rotation, a visible distance (FOV), and the like.

For example, during development of a game, a developer configures a state parameter for a virtual camera that displays corresponding information or different function interfaces, so that during running of the game, the virtual camera is controlled based on the state parameter corresponding to the virtual camera, to display object information or a function interface, so as to ensure a subsequent display effect.

Based on the foregoing embodiments shown in FIG. 2 to FIG. 11, in an embodiment of this application, the scene interface further provides a shortcut access function, and information is displayed in a second region on the scene interface. In other words, the method further includes the following operation: displaying, in response to a touch operation on the second region on the scene interface, a function interface associated with the information.

The information displayed in the second region is any information. For example, the information displayed in the second region indicates a virtual sprite that the virtual object chooses to carry, or indicates a virtual prop that has been equipped, or indicates specified task information, or indicates a current orientation of the virtual object.

In this embodiment of this application, the scene interface further provides a function of a shortcut operation. Though the touch operation on the second region, the function interface associated with the information displayed in the second region can be displayed, so that the user controls the displayed information, and a function of accessing the function interface associated with the information displayed in the second region can be quickly implemented, to facilitate user operations, and the shortcut operation improves usability.

In some embodiments, the touch operation on the second region can be any operation. For example, the touch operation on the second region is a long press/touch and hold operation, a click/tap operation, a slide operation, or the like.

In some embodiments, the scene interface includes a plurality of second regions. Different second regions display different information. In response to a touch operation on any second region, a function interface associated with information in the second region is displayed.

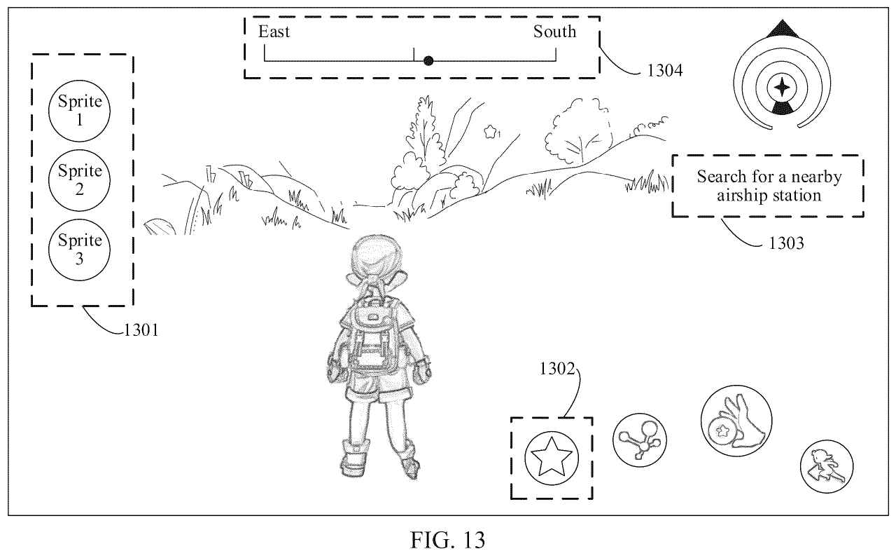

As shown in FIG. 13, a scene interface includes four second regions. A virtual sprite carried by a virtual object is displayed in the 1^{st} second region 1301. An equipped virtual magic ball is displayed in the 2^{nd} second region 1302. Specified task information is displayed in the 3^{rd} second region 1303. A current orientation of the virtual object is displayed in the 4^{th} second region 1304. In response to a long press/touch and hold operation on the 1^{st} second region, a sprite system interface is displayed, so that a user performs an operation on a virtual sprite. For example, in the sprite system interface, a carried virtual sprite can be replaced, or a capability of a virtual sprite can be developed. In response to a long press/touch and hold operation on the 2^{nd} second region, a magic ball selection interface is displayed, so that the user changes the equipped virtual magic ball on the magic ball selection interface. In response to a long press/touch and hold operation on the 3^{rd} second region, a task interface is displayed, so that the user views the task information of the virtual object on the task interface. In response to a long press/touch and hold operation on the 4^{th} second region, a large map system interface is displayed, so that the user views a position of the virtual object in the virtual scene and the current orientation of the virtual object on the large map system interface, to facilitate the virtual object to locate a target position and plan a route to the target position.

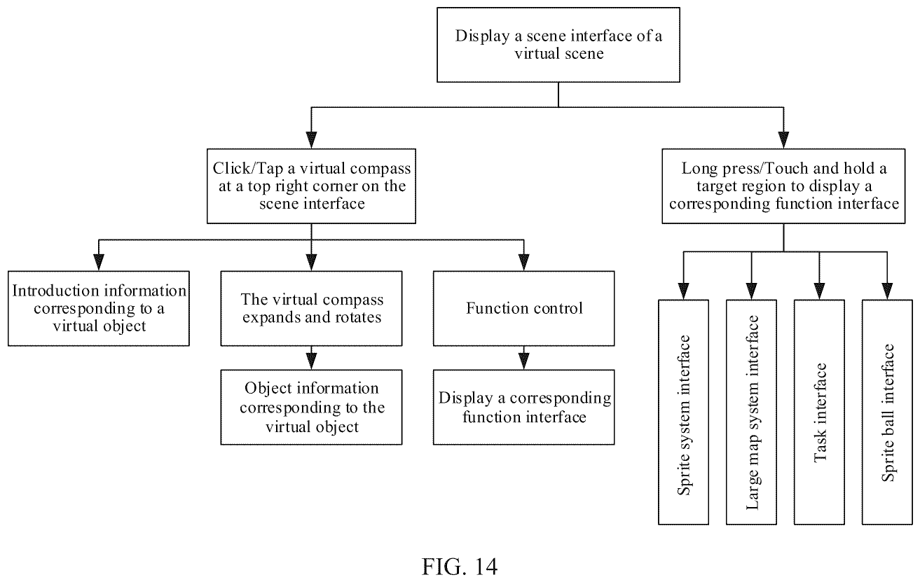

Based on the foregoing embodiments shown in FIG. 2 to FIG. 11, an embodiment of this application further provides a flowchart of a function control display method. As shown in FIG. 14, the method includes the following operations:

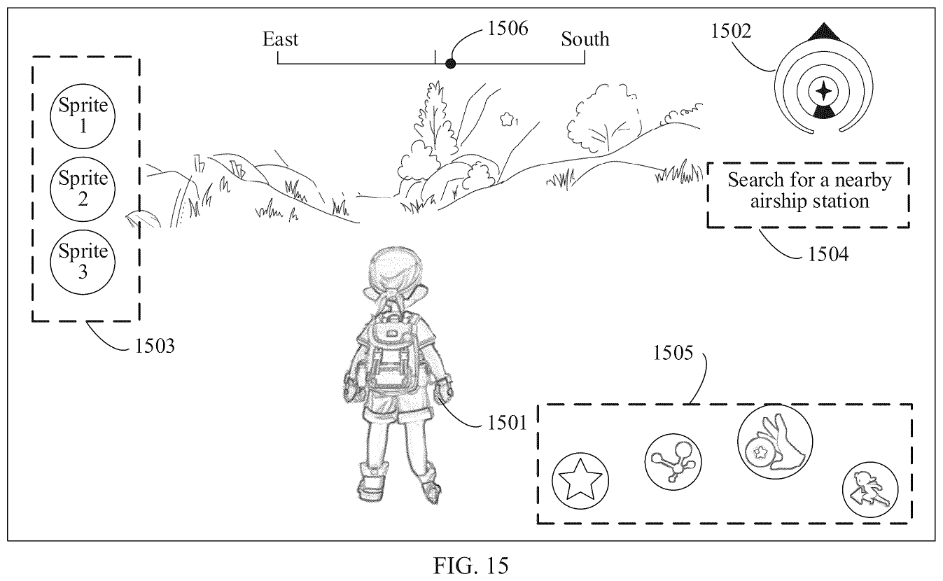

Operation 1: A terminal displays a scene interface of a virtual scene. The scene interface is shown in FIG. 15. A virtual object 1501 controlled by the terminal and a touch entry 1502 of a virtual compass are displayed on the scene interface, and the touch entry 1502 is displayed in a form of the virtual compass in a folded state.

In addition, pet information 1503, specified task information 1504, and an operating control 1505 are further displayed on the virtual scene interface, and an orientation 1506 of the virtual object is displayed below the touch entry 1502.

Operation 2: A user clicks/taps, the touch entry 1502 of the virtual compass by using the terminal. The terminal displays in a blurred manner, on the scene interface, a virtual scene photographed in a process in which the virtual camera changes from a current position to a second position, displays, on the scene interface on which the blurring has been performed, the virtual object performing a hand-raising action and the virtual compass appearing in the virtual scene when being called, plays an animation in which the virtual compass switches from a folded state to an expanded state, and displays a plurality of function controls moving from positions on the virtual compass toward positions around the virtual compass and are uniformly displayed around the virtual compass and distributed in a ring shape. A direction indication region of the first virtual ring of the virtual compass points to north in the virtual scene, a ray emitting region of the second virtual ring emits a ray, and the ray points to a position that the virtual object needs to arrive at when a specified task is completed. In addition, the terminal displays introduction information of the virtual object above the virtual compass in the expanded state.

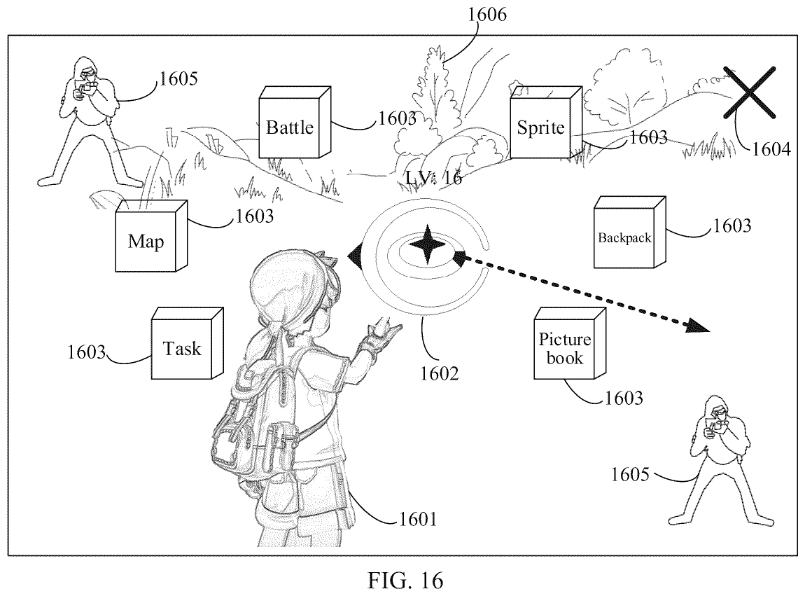

For example, the user clicks/taps the touch entry 1502 of the virtual compass by using the terminal, and the scene interface on which the blurring has been performed is shown in FIG. 16. A virtual object 1601 performing a hand-raising action is displayed on the scene interface on which the blurring has been performed, and a hand of the virtual object 1601 points to a virtual compass 1602 in an expanded state. Function controls 1603 associated with the virtual compass 1602 are displayed around the virtual compass 1602 and distributed in a ring shape with a display position of the virtual compass 1602 at the center. In addition, introduction information of the virtual object 1601 is further displayed above the virtual compass 1602. The introduction information indicates that a level of the virtual object 1601 is 16. In addition, the introduction information may further include other information. In addition, a close option 1604 is displayed at an upper right corner of the scene interface. If the user clicks/taps the close option 1604, currently displayed content is canceled on the scene interface, and the virtual object 1601 and touch entry of the virtual compass are displayed. In other words, after the user clicks/taps the close option 1604, the content displayed on the scene interface is the same as the content shown in the figure. In addition, a virtual scene in the scene interface on which the blurring has been performed is displayed in a blurred manner, another virtual object 1605 around the virtual object 1601 in the scene interface on which the blurring has been performed is displayed in a blurred manner, and a virtual plant 1606 around the virtual object is also displayed in a blurred manner. When the virtual compass and the plurality of function controls appear in the virtual scene when being activated by the virtual object, a process of a game continues and is not interrupted. In this case, the virtual object 1601 can be attacked by the surrounding virtual object 1605. The virtual scene is displayed in a blurred manner, so that the virtual compass 1602 and the function controls 1603 can be clearly displayed. In addition, the user can further learn of situations around the virtual object 1601 by observing the blurred virtual scene, and determine whether an ambient environment of the virtual object is dangerous. When the virtual object is in a dangerous environment, the user can close the displayed virtual compass and function controls in a timely manner, to control the virtual object to avoid danger. In some embodiments, when the virtual compass 1602 and the function controls 1603 appear when being activated by the virtual object 1601, the virtual object 1601 is in an attackable state. For example, a special effect of “invincible” is displayed around the virtual object 1601, and the virtual object 1605 in a virtual environment in which the virtual object 1601 is located cannot attack the virtual object 1601. However, in this case, the virtual object 1605 can move around the virtual object 1601, to attack the virtual object 1601 when the virtual object 1601 cancels calling the virtual compass.

Operation 3: The user clicks/taps any function control by using the terminal, and the terminal displays a function interface corresponding to the function control.

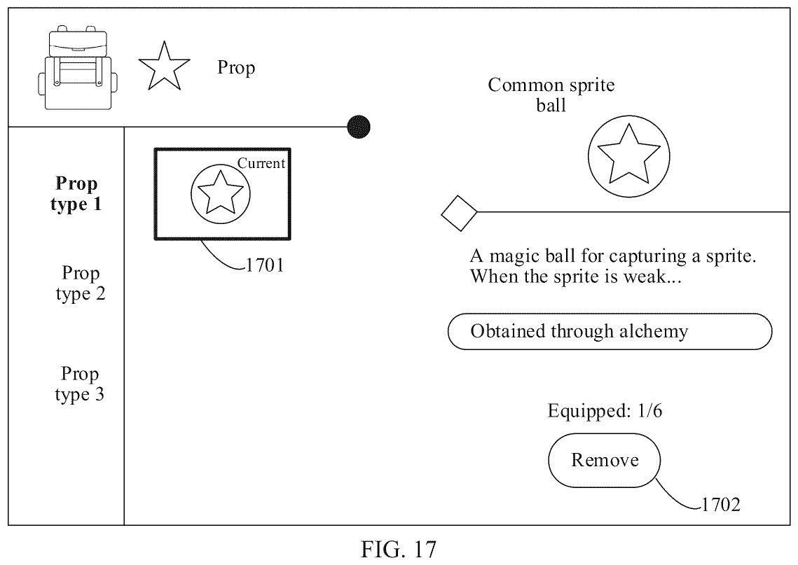

As shown in FIG. 16, the function controls 1603 displayed on the scene interface include a battle control, a map control, a task control, a sprite control, a backpack control, and a picture book control. An example in which the user clicks/taps the backpack control is used. After the user clicks the backpack control, a backpack interface displayed by the terminal is shown in FIG. 17. A virtual prop owned by the virtual object can be displayed on the backpack interface in different types. An example in which an equipped virtual magic ball 1701 is currently displayed is used. The user clicks/taps the displayed virtual magic ball 1701, detailed information of the virtual magic ball 1701 and a remove control 1702 are displayed in a right region on the backpack interface. The remove control 1702 is configured for removing the virtual magic ball for the virtual object.

Operation 4: The user clicks/taps the virtual compass in an expanded state by using the terminal, and the terminal displays, on the scene interface on which the blurring has been performed, the virtual compass moving leftward, keeps displaying the virtual compass in a left region on the scene interface, and displays object information of the virtual object in a right region on the scene interface.

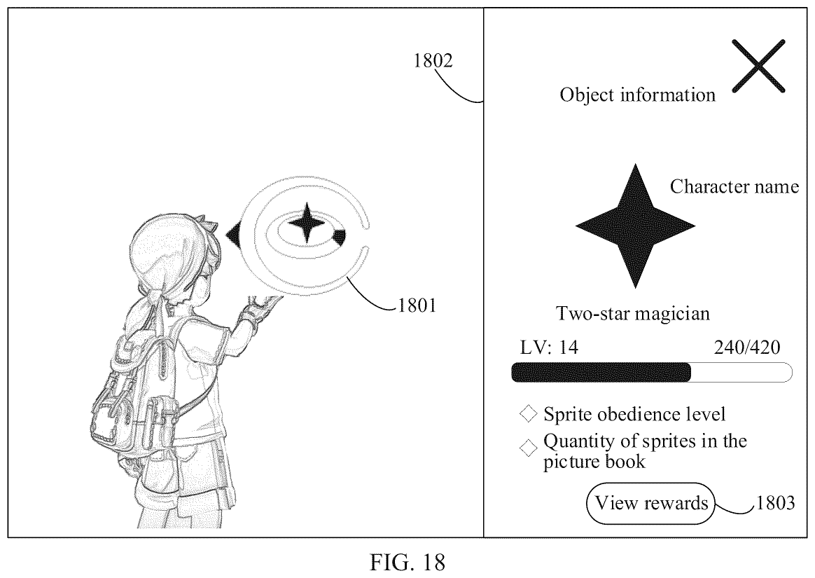

As shown in FIG. 18, after the user clicks/taps a virtual compass 1801 in an expanded state by using the terminal, object information 1802 displayed on the scene interface includes a level of the virtual object, an object name, a quantity of owned virtual sprites, a level of a virtual sprite, and a reward viewing control 1803. The reward viewing control 1803 is configured for viewing obtained rewards and the like.

Operation 5: The user long presses/touches and holds, by using the terminal, a first target region in the virtual scene in which a virtual sprite carried by the virtual object is displayed, and the terminal displays a sprite system interface. The user long presses/touches and holds, by using the terminal, a second target region in the virtual scene in which a current orientation of the virtual object is displayed, and the terminal displays a large map system interface. The user long presses/touches and holds, by using the terminal, a third target region in the virtual scene in which specified task information is displayed, and the terminal displays the task interface. The user long presses/touches and holds, by using the terminal, a fourth target region in the virtual scene in which the equipped virtual magic ball is displayed, and the terminal displays a magic ball selection interface.

Based on the foregoing embodiments shown in FIG. 2 to FIG. 18, the virtual scene in an embodiment of this application is provided as a three-dimensional virtual scene, and the virtual object, the virtual compass, and the function controls are all displayed in a form of a three-dimensional (3D) model. In other words, the virtual object is a three-dimensional virtual object, the virtual compass is a three-dimensional virtual compass, and the function controls are three-dimensional function controls.

In the three-dimensional virtual scene, the three-dimensional virtual compass and the three-dimensional function controls appear in the three-dimensional virtual scene when being called by the three-dimensional virtual object, and the function controls are displayed in a novel form of a 3D model. In addition, the three-dimensional function controls appear in the virtual scene when being called rather than only controls displayed on the scene interface, so that fusion between the three-dimensional function controls displayed on the scene interface and the three-dimensional virtual scene is high, to improve a display effect of the function controls. In addition, the three-dimensional virtual compass and the three-dimensional function controls appearing in the three-dimensional virtual scene when being called by the three-dimensional virtual object, so that when the three-dimensional virtual compass and the three-dimensional function controls appearing when being called, the user can still view the displayed three-dimensional virtual scene.

In some embodiments, the touch entry of the virtual compass is also displayed by using the 3D model. In other words, the touch entry is a three-dimensional touch entry. In this embodiment of this application, the three-dimensional touch entry is an entry displayed in the three-dimensional virtual scene rather than an entry displayed on the scene interface, so that fusion between the three-dimensional touch entry displayed on the scene interface and the three-dimensional virtual scene is high, to improve a display effect of the touch entry.

Based on the foregoing embodiments shown in FIG. 2 to FIG. 18, the terminal controls creation and destruction of the virtual compass and the function control by using a life cycle of a virtual engine (UMG). In response to a touch operation on the touch entry on the scene interface, which is equivalent to a start time point of the life cycle of the virtual engine, the terminal creates the virtual compass and the function controls by using the virtual engine. In other words, the virtual compass and the function controls appearing in the virtual scene when being activated by the virtual object is displayed on the scene interface. In response to a close operation on the virtual compass and the function controls displayed on the scene interface, which is equivalent to an end time point of the life cycle of the virtual engine, the virtual compass and the function controls are destroyed by using the virtual engine. In other words, the display of the virtual engine and the function controls is canceled on the scene interface, and the virtual object and the touch entry of the virtual compass are displayed.

In addition, when the virtual compass and the function controls are displayed on the scene interface by using the virtual engine, in response to a touch operation on any position on the scene interface, a triggered function control or virtual compass is determined by using the virtual engine in a ray detection manner based on coordinates of the position on a terminal screen, and a function interface corresponding to the triggered function control is further displayed, or the object information is displayed on the scene interface.

In addition, the function controls displayed on the scene interface are located at the upmost of the screen, to avoid that the function controls are blocked by another object in the virtual scene. In addition, when the function controls are displayed on the scene interface, a collision path is set for the function controls and the virtual compass, to ensure that the displayed virtual compass and function controls can be triggered by bypassing a model of another object in the virtual scene.

For example, a parameter of a custom depth of the function control is adjusted, to ensure that the function control is rendered at the upmost of the screen.

In a possible implementation, the virtual compass is bound to a mounting point of the target part of the virtual object, and the function controls associated with the virtual compass are bound to the mounting point of the virtual compass. The mounting point is configured for mounting different models together in the virtual scene.

In this embodiment of this application, the virtual compass is mounted to the target part of the virtual object, and the function controls associated with the virtual compass are mounted to the virtual compass, so that when the virtual object calls the virtual compass in the virtual scene, the virtual object performs, with the target part, an action of calling the virtual compass, and the virtual compass is displayed at a position where the target part stays, in other words, an effect that the target part points to the virtual compass is exhibited. In addition, the function controls gradually spreading out around the virtual compass with the mounting point of the virtual compass at the center is displayed, to exhibit an effect that the virtual compass controls the virtual compass with the target part and an effect that the virtual compass controls the function controls to spread out.

For example, the virtual compass is an independent blueprint (BP), that is, an independent operation method container, and the virtual compass switching from a folded state to an expanded state and the function controls being displayed are an integral BP. In addition, a process of switching the virtual compass from the folded state to the expanded state and the function controls being displayed is made into an animation, and a process of switching the virtual compass from the expanded state to the folded state is also made into an animation. The virtual compass BP is bound to a hand mounting point of the virtual object, and the BP for switching the virtual compass from the folded state to the expanded state is bound to a central mounting point of the virtual compass BP, so that in response to the touch operation on the touch entry of the virtual compass, a hand of the virtual object raising is displayed on the scene interface, and the animation in which the virtual compass switches from the folded state to the expanded state is played. The virtual compass in the expanded state and the hand of the virtual object are at the same position, to ensure that the virtual compass in the expanded state can face toward the camera in the virtual scene, so that the virtual compass in the expanded state can be presented in a forward direction. In some embodiments, a rotation angle of the virtual compass in the expanded state is determined based on an orientation of the virtual object, and the virtual compass in the expanded state is rotated based on the rotation angle, so that the virtual compass in the expanded state directly faces toward the camera in the virtual scene.

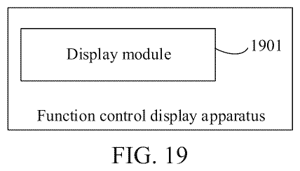

FIG. 19 is a schematic diagram of a structure of a function control display apparatus according to an embodiment of this application. As shown in FIG. 19, the apparatus includes:
a display module 1901, configured to display a scene interface of a virtual scene, a virtual object and a touch entry of a virtual compass being displayed on the scene interface, the touch entry being configured for controlling the virtual object to call the virtual compass, to display a plurality of function controls associated with the virtual compass, and the function controls being configured for triggering corresponding functions.

The display module 1901 is further configured to: blur, in response to a touch operation on the touch entry, the virtual scene displayed on the scene interface; display, on the scene interface on which the blurring has been performed, the virtual compass appearing in the virtual scene when being activated by the virtual object; and display the plurality of function controls around the virtual compass.

In a possible implementation, the display module 1901 is further configured to: blur, in response to the touch operation on the touch entry, the virtual scene displayed on the scene interface; display, on the scene interface on which the blurring has been performed, an action of calling the virtual compass performed by the virtual object with a target part; display the virtual compass on the scene interface on which the blurring has been performed; and display the plurality of function controls around the virtual compass, the target part of the virtual object pointing to the virtual compass.

In another possible implementation, the touch entry is displayed in a form of the virtual compass in a first state. The display module 1901 is configured to: blur, in response to the touch operation on the touch entry, the virtual scene displayed on the scene interface; play, on the scene interface on which the blurring has been performed, an animation in which the virtual compass switches from the first state to a second state; display the virtual compass in the second state on the scene interface on which the blurring has been performed; and display the plurality of function controls around the virtual compass.

In another possible implementation, the display module 1901 is configured to: blur, in response to the touch operation on the touch entry, the virtual scene displayed on the scene interface; display, on the scene interface on which the blurring has been performed, the virtual compass appearing when being activated by the virtual object; and display the plurality of function controls moving from positions on the virtual compass toward positions around the virtual compass, to reach a first position associated with a display position of the virtual compass, the plurality of function controls being distributed around the virtual compass in a ring shape with the virtual compass at the center.

In another possible implementation, the virtual compass is formed by a first virtual ring and a second virtual ring, the first virtual ring points to a target direction in the virtual scene, and the second virtual ring points to a to-be-reached destination.

In another possible implementation, the display module 1901 is further configured to display, on the scene interface on which the blurring has been performed, a ray pointing to the destination emitted by the second virtual ring.

In another possible implementation, the display module 1901 is configured to: change a virtual camera in the virtual scene from a current position to a second position in response to the touch operation on the touch entry, the second position having a preset relative positional relationship with the virtual object; blur, during the changing of the virtual camera from the current position to the second position, a virtual scene that is photographed by the virtual camera and that is displayed on the scene interface; display, on the scene interface on which the blurring has been performed, the virtual compass appearing when being activated by the virtual object; and display the plurality of function controls around the virtual compass.

In another possible implementation, the display module 1901 is configured to: blur, in response to the touch operation on the touch entry, the virtual scene displayed on the scene interface; increase a focal length of a virtual camera in the virtual scene, to zoom in and display an image photographed by the virtual camera; display, on the scene interface on which the blurring has been performed, the virtual compass appearing in the virtual scene when being activated by the virtual object; and display the plurality of function controls around the virtual compass.

In another possible implementation, the display module 1901 is further configured to: display a wind field special effect on the scene interface on which the blurring has been performed; and display, during the display of the wind field special effect, the plurality of function controls swaying with the wind field special effect on the scene interface on which the blurring has been performed.

In another possible implementation, the display module 1901 is further configured to: display, in response to a posture change of a local device being detected, a display angle of the plurality of function controls varying with the posture change of the local device in the virtual scene on which the blurring has been performed; or adjust, in response to a posture change of a local device being detected, a photography perspective of the virtual camera in the virtual scene to vary with the posture change of the local device, to display a virtual scene photographed by the virtual camera in the blurred virtual scene.

In another possible implementation, the display module 1901 is further configured to: display, in response to a touch operation on any function control, a function interface corresponding to the function control; or display, in response to a touch operation on the virtual compass, object information corresponding to the virtual object.

In another possible implementation, the display module 1901 is configured to: display, in response to the touch operation on the virtual compass, the virtual object and the virtual compass moving in a first direction and then stopping on the scene interface on which the blurring has been performed; and display, while keeping the virtual object and the virtual compass displayed, the object information of the virtual object in a first region on the scene interface on which the blurring has been performed, the first region being located in a second direction of the virtual compass, and the first direction being opposite to the second direction.

In another possible implementation, information is displayed in a second region on the scene interface. The display module 1901 is further configured to display, in response to a touch operation on the second region on the scene interface, a function interface associated with the information.

In the function control display apparatus provided in the foregoing embodiments, the division of the foregoing functional modules is merely described as an example. In actual application, the foregoing functions may be assigned as needed to be implemented by different functional modules. In other words, an internal structure of the terminal is divided into different functional modules, to implement all or some of the functions described above. In addition, the function control display apparatus provided in the foregoing embodiments and the function control display method embodiments fall within the same conception. For details of a specific implementation process, refer to the method embodiments. Details are not described herein again.

An embodiment of this application further provides a terminal. The terminal includes a processor and a memory. The memory has at least one computer program stored therein, and the at least one computer program is loaded and executed by the processor to implement operations performed in the function control display method in the foregoing embodiments.

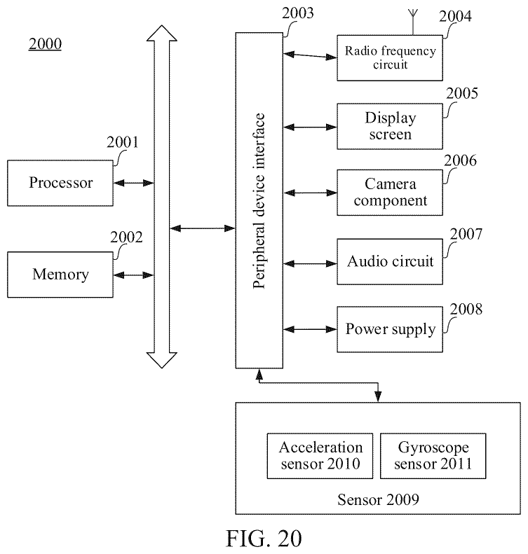

FIG. 20 is a block diagram of a structure of a terminal 2000 according to an exemplary embodiment of this application. The terminal 2000 includes a processor 2001 and a memory 2002.

The processor 2001 may include one or more processing cores, for example, a 4-core processor or an 8-core processor. The processor 2001 may be implemented in at least one hardware form of a digital signal processor (DSP), a field-programmable gate array (FPGA), and a programmable logic array (PLA). The processor 2001 may alternatively include a main processor and a coprocessor. The main processor is a processor configured to process data in an awake state, and is also referred to as a central processing unit (CPU). The coprocessor is a low-power-consumption processor configured to process data in a standby state. In some embodiments, the processor 2001 may be integrated with a graphics processing unit (GPU). The GPU is configured to render and draw content that needs to be displayed on a display screen. In some embodiments, the processor 2001 may further include an AI processor. The AI processor is configured to process computing operations related to machine learning.

The memory 2002 may include one or more computer-readable storage media. The computer-readable storage medium may be non-transitory. The memory 2002 may further include a high-speed random access memory and a non-volatile memory, for example, one or more disk storage devices or flash storage devices. In some embodiments, the non-transitory computer-readable storage medium in the memory 2002 is configured to store at least one computer program. The at least one computer program is configured to be executed by the processor 2001 to implement the function control display method provided in the method embodiments of this application.

In some embodiments, the terminal 2000 may further include a peripheral device interface 2003 and at least one peripheral device. The processor 2001, the memory 2002, and the peripheral device interface 2003 may be connected through a bus or a signal cable. Each peripheral device may be connected to the peripheral device interface 2003 through a bus, a signal cable, or a circuit board. Specifically, the peripheral device includes at least one of a radio frequency circuit 2004, a display screen 2005, a camera component 2006, an audio circuit 2007, or a power supply 2008.

The peripheral device interface 2003 may be configured to connect the at least one peripheral device related to input/output (I/O) to the processor 2001 and the memory 2002. In some embodiments, the processor 2001, the memory 2002, and the peripheral device interface 2003 are integrated on the same chip or circuit board. In some other embodiments, any one or two of the processor 2001, the memory 2002, and the peripheral device interface 2003 may be implemented on a single chip or circuit board, which is not limited in this embodiment.

The radio frequency circuit 2004 is configured to receive and transmit a radio frequency (RF) signal, also referred to as an electromagnetic signal. The radio frequency circuit 2004 communicates with a communication network and other communication devices through the electromagnetic signal. The radio frequency circuit 2004 converts an electric signal into an electromagnetic signal for transmission, or converts a received electromagnetic signal into an electric signal. In some embodiments, the radio frequency circuit 2004 includes an antenna system, an RF transceiver, one or more amplifiers, a tuner, an oscillator, a digital signal processor, a codec chip set, a subscriber identity module card, and the like. The radio frequency circuit 2004 may communicate with other terminals by using at least one wireless communication protocol. The wireless communication protocol includes but is not limited to: the World Wide Web, a metropolitan area network, the Intranet, various generations of mobile communication networks (2G, 3G, 4G, and 5G), a wireless local area network, and/or a wireless fidelity (Wi-Fi) network. In some embodiments, the radio frequency circuit 2004 may further include a circuit related to near field communication (NFC), which is not limited in this application.

The display screen 2005 is configured to display a user interface (UI). The UI may include a graph, text, an icon, a video, and any combination thereof. When the display screen 2005 is a touch display screen, the display screen 2005 further has a capability of collecting a touch signal on or above a surface of the display screen 2005. The touch signal may be inputted to the processor 2001 as a control signal for processing. In this case, the display screen 2005 may be further configured to provide a virtual button and/or a virtual keyboard that are/is also referred to as a soft button and/or a soft keyboard. In some embodiments, there may be one display screen 2005 disposed on a front panel of the terminal 2000. In some other embodiments, there may be at least two display screens 2005 disposed on different surfaces of the terminal 2000 respectively or in a folded design. In some other embodiments, the display screen 2005 may be a flexible display screen disposed on a curved surface or a folded surface of the terminal 2000. Even, the display screen 2005 may be further configured in a non-rectangular irregular pattern, namely, a special-shaped screen. The display screen 2005 may be prepared by using materials such as a liquid crystal display (LCD) or an organic light-emitting diode (OLED).

The camera component 2006 is configured to capture images or videos. In some embodiments, the camera component 2006 includes a front-facing camera and a rear-facing camera. The front-facing camera is disposed on the front panel of the terminal, and the rear-facing camera is disposed on a back surface of the terminal. In some embodiments, there are at least two rear-facing cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 2006 may further include a flash. The flash may be a monochrome temperature flash, or may be a double color temperature flash. The double color temperature flash is a combination of a warm light flash and a cold light flash, and may be used for light compensation under different color temperatures.

The audio circuit 2007 may include a microphone and a speaker. The microphone is configured to acquire acoustic waves of a user and an environment, and convert the acoustic waves into an electrical signal to input to the processor 2001 for processing, or input to the radio frequency circuit 2004 for implementing voice communication. For a purpose of stereo acquisition or noise reduction, there may be a plurality of microphones, respectively disposed at different portions of the terminal 2000. The microphone may alternatively be an array microphone or an omni-directional acquisition type microphone. The speaker is configured to convert an electric signal from the processor 2001 or the radio frequency circuit 2004 into acoustic waves. The speaker may be a conventional film speaker, or may be a piezoelectric ceramic speaker. When the speaker is a piezoelectric ceramic speaker, the speaker not only can convert an electrical signal into acoustic waves audible to a human being, but also can convert an electrical signal into acoustic waves inaudible to a human being, for ranging and other purposes. In some embodiments, the audio circuit 2007 may further include an earphone jack.

The power supply 2008 is configured to supply power to components in the terminal 2000. The power supply 2008 may be an alternating current, a direct current, a disposable battery, or a rechargeable battery. When the power supply 2008 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 2000 further includes one or more sensors 2009. The one or more sensors 2009 include but are not limited to an acceleration sensor 2010 and a gyroscope sensor 2011.

The acceleration sensor 2010 may detect a magnitude of acceleration on three coordinate axes of a coordinate system established by the terminal 2000. For example, the acceleration sensor 2010 may be configured to detect a component of gravity acceleration on the three coordinate axes. The processor 2001 may control, based on a gravity acceleration signal acquired by the acceleration sensor 2010, the display screen to display the user interface in a horizontal-view mode or a vertical-view mode. The acceleration sensor 2010 may be further configured to collect data of a game or a user movement.

The gyroscope sensor 2011 may detect a body direction and a rotation angle of the terminal 2000. The gyroscope sensor 2011 may cooperate with the acceleration sensor 2010 to acquire 3D actions by the user on the terminal 2000. The processor 2001 may implement the following functions based on the data acquired by the gyroscope sensor 2011: motion sensing (for example, changing the UI based on a tilt operation by the user), image stabilization during photographing, game control, and inertial navigation.

A person skilled in the art may understand that the structure shown in FIG. 20 does not constitute a limitation to the terminal 2000, and the terminal may include more or fewer components than those shown in the figure, or some components may be combined, or a different component deployment may be used.

An embodiment of this application further provides a non-transitory computer-readable storage medium. The computer-readable storage medium has at least one computer program stored thereon, and the at least one computer program is loaded and executed by a processor to implement operations performed in the function control display method according to the foregoing embodiments.

An embodiment of this application further provides a computer program product. The computer program product includes a computer program, and the computer program, when executed by a processor, implements operations performed in the function control display method according to the foregoing aspect.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely exemplary embodiments of embodiments of this application, and are not intended to limit embodiments of this application. Any modification, equivalent replacement, improvement, or the like made within the spirit and principle of embodiments of this application shall fall within the protection scope of this application.

What is claimed is:

1. A function control display method performed by a computer device, the method comprising:
displaying a scene interface of a virtual scene, a virtual object and a touch entry of a virtual compass being displayed on the scene interface, the touch entry being configured for controlling the virtual object to activate the virtual compass, to display a plurality of function controls associated with the virtual compass, and the function controls being configured for triggering corresponding functions;
in response to a touch operation on the touch entry without interrupting a process corresponding to the virtual scene, blurring the virtual scene on the scene interface; and
displaying, on the scene interface, a scene in which the virtual compass appears in the virtual scene after being activated by the virtual object and displaying the plurality of function controls around the virtual compass.

2. The method according to claim 1, wherein the displaying, on the scene interface, a scene in which the virtual compass appears in the virtual scene after being activated by the virtual object and displaying the plurality of function controls around the virtual compass comprises:
displaying, on the scene interface, an action of activating the virtual compass performed by the virtual object with a target part; and
displaying the virtual compass on the scene interface and the plurality of function controls around the virtual compass, the target part of the virtual object pointing to the virtual compass.

3. The method according to claim 1, wherein the touch entry is displayed in a form of the virtual compass in a first state, and the displaying, on the scene interface on which the blurred display has been performed, a scene in which the virtual compass appears in the virtual scene when being activated by the virtual object, and displaying the plurality of function controls around the virtual compass comprises:
playing, on the scene interface on which the blurred display has been performed, an animation in which the virtual compass switches from the first state to a second state; and
displaying the virtual compass in the second state on the scene interface on which the blurred display has been performed, and displaying the plurality of function controls around the virtual compass.

4. The method according to claim 1, wherein the displaying the plurality of function controls around the virtual compass comprises:
displaying the plurality of function controls moving from positions on the virtual compass toward positions around the virtual compass, to reach a first position associated with a display position of the virtual compass, the plurality of function controls at the first position being distributed around the virtual compass in a ring shape with the virtual compass at the center.

5. The method according to claim 1, wherein the virtual compass is formed by a first virtual ring and a second virtual ring, the first virtual ring points to a target direction in the virtual scene, and the second virtual ring points to a to-be-reached destination.

6. The method according to claim 1, wherein the blurring the virtual scene displayed on the scene interface comprises:
changing a virtual camera in the virtual scene from a current position to a second position in response to the touch operation on the touch entry, the second position having a preset relative positional relationship with the virtual object; and
displaying, during the changing of the virtual camera from the current position to the second position, a virtual scene that is photographed by the virtual camera in a blurred manner on the scene interface.

7. The method according to claim 1, wherein the blurring the virtual scene displayed on the scene interface comprises:
displaying the virtual scene in a blurred manner on the scene interface; and
increasing a focal length of a virtual camera in the virtual scene, to zoom in and display an image photographed by the virtual camera.

8. The method according to claim 1, wherein the method further comprises:
displaying a wind field special effect on the scene interface; and
displaying, during the display of the wind field special effect, the plurality of function controls swaying with the wind field special effect on the scene interface.

9. The method according to claim 1, wherein the method further comprises:
displaying, in response to a posture change of a local device being detected, a display angle of the plurality of function controls varying with the posture change of the local device in the virtual scene; or
adjusting, in response to the posture change of a local device being detected, a photography perspective of a virtual camera in the virtual scene to vary with the posture change of the local device, to display the blurred virtual scene photographed by the virtual camera.

10. The method according to claim 1, wherein the method further comprises:
displaying, in response to a touch operation on any function control, a function interface corresponding to the function control; or
displaying, in response to a touch operation on the virtual compass, object information corresponding to the virtual object.

11. A computer device, comprising a processor and a memory, the memory having at least one computer program stored therein, and the at least one computer program being loaded and executed by the processor to cause the computer device to implement a function control display method including:
displaying a scene interface of a virtual scene, a virtual object and a touch entry of a virtual compass being displayed on the scene interface, the touch entry being configured for controlling the virtual object to activate the virtual compass, to display a plurality of function controls associated with the virtual compass, and the function controls being configured for triggering corresponding functions;
in response to a touch operation on the touch entry without interrupting a process corresponding to the virtual scene, blurring the virtual scene on the scene interface; and
displaying, on the scene interface, a scene in which the virtual compass appears in the virtual scene after being activated by the virtual object and displaying the plurality of function controls around the virtual compass.

12. The computer device according to claim 11, wherein the displaying, on the scene interface, a scene in which the virtual compass appears in the virtual scene after being activated by the virtual object and displaying the plurality of function controls around the virtual compass comprises:
displaying, on the scene interface, an action of activating the virtual compass performed by the virtual object with a target part; and
displaying the virtual compass on the scene interface and the plurality of function controls around the virtual compass, the target part of the virtual object pointing to the virtual compass.

13. The computer device according to claim 11, wherein the touch entry is displayed in a form of the virtual compass in a first state, and the displaying, on the scene interface on which the blurred display has been performed, a scene in which the virtual compass appears in the virtual scene when being activated by the virtual object, and displaying the plurality of function controls around the virtual compass comprises:
playing, on the scene interface on which the blurred display has been performed, an animation in which the virtual compass switches from the first state to a second state; and
displaying the virtual compass in the second state on the scene interface on which the blurred display has been performed, and displaying the plurality of function controls around the virtual compass.

14. The computer device according to claim 11, wherein the displaying the plurality of function controls around the virtual compass comprises:
displaying the plurality of function controls moving from positions on the virtual compass toward positions around the virtual compass, to reach a first position associated with a display position of the virtual compass, the plurality of function controls at the first position being distributed around the virtual compass in a ring shape with the virtual compass at the center.

15. The computer device according to claim 11, wherein the virtual compass is formed by a first virtual ring and a second virtual ring, the first virtual ring points to a target direction in the virtual scene, and the second virtual ring points to a to-be-reached destination.

16. The computer device according to claim 11, wherein the blurring the virtual scene displayed on the scene interface comprises:
changing a virtual camera in the virtual scene from a current position to a second position in response to the touch operation on the touch entry, the second position having a preset relative positional relationship with the virtual object; and
displaying, during the changing of the virtual camera from the current position to the second position, a virtual scene that is photographed by the virtual camera in a blurred manner on the scene interface.

17. The computer device according to claim 11, wherein the blurring the virtual scene displayed on the scene interface comprises:
displaying the virtual scene in a blurred manner on the scene interface; and
increasing a focal length of a virtual camera in the virtual scene, to zoom in and display an image photographed by the virtual camera.

18. The computer device according to claim 11, wherein the method further comprises:
displaying a wind field special effect on the scene interface; and
displaying, during the display of the wind field special effect, the plurality of function controls swaying with the wind field special effect on the scene interface.

19. The computer device according to claim 11, wherein the method further comprises:
displaying, in response to a posture change of a local device being detected, a display angle of the plurality of function controls varying with the posture change of the local device in the virtual scene; or
adjusting, in response to the posture change of a local device being detected, a photography perspective of a virtual camera in the virtual scene to vary with the posture change of the local device, to display the blurred virtual scene photographed by the virtual camera.

20. A non-transitory computer-readable storage medium, having at least one computer program stored thereon, the at least one computer program being loaded and executed by a processor of a computer device to cause the computer device to implement a function control display method including:
displaying a scene interface of a virtual scene, a virtual object and a touch entry of a virtual compass being displayed on the scene interface, the touch entry being configured for controlling the virtual object to activate the virtual compass, to display a plurality of function controls associated with the virtual compass, and the function controls being configured for triggering corresponding functions;
in response to a touch operation on the touch entry without interrupting a process corresponding to the virtual scene, blurring the virtual scene on the scene interface; and
displaying, on the scene interface, a scene in which the virtual compass appears in the virtual scene after being activated by the virtual object and displaying the plurality of function controls around the virtual compass.
